(19) United States
(12) Patent Application Publication
(10) Pub. No.: US 2012/0072263 A1
(43) Pub. Date: Mar. 22, 2012

(54) SELECTING AND PROCESSING OFFERS TO COMPLETE TASKS, RESEARCH PROGRAMS, AND CONSUMER REWARDS PROGRAMS BASED ON LOCATION

(76) Inventors: Matthew Dusig, Pacific Palisades, CA (US); Gregg Lavin, Thousand Oaks, CA (US); Steven Sobolevsky, Tarzana, CA (US)

(21) Appl. No.: 13/211,708

(22) Filed: Aug. 17, 2011

Related U.S. Application Data
(60) Provisional application No. 61/476,803, filed on Apr. 19, 2011.
(60) Provisional application No. 61/476,802, filed on Apr. 19, 2011.
(60) Provisional application No. 61/374,609, filed on Aug. 17, 2010.

(51) Int. Cl. G06Q 30/02

(52) U.S. Cl. 705/7.32

(57) ABSTRACT

The present disclosure describes, among other things, a method. The method may include receiving a location associated with a user and a mobile device. The method may also include determining a research program for a vendor based at least in part on the location. The method may also include sending information about the research program to the mobile device. The method may also include receiving a request for participation in the research program. The method may also include sending at least one inquiry associated with the research program to the mobile device. The method may also include receiving a response to the at least one inquiry from the mobile device.

### RELATED APPLICATIONS

This patent application claims priority to U.S. application Ser. No. 61/374,609, entitled “Location Based Market Research and Rewards Program,” filed Aug. 17, 2010, which is hereby incorporated by reference in its entirety.

This patent application claims priority to U.S. application Ser. No. 61/476,802, entitled “Location Based Market Research Program,” filed Apr. 19, 2011, which is hereby incorporated by reference in its entirety.

This patent application claims priority to U.S. application Ser. No. 61/476,803, entitled “Location Based Consumer Rewards Program,” filed Apr. 19, 2011, which is hereby incorporated by reference in its entirety.

This patent application is related to U.S. application Ser. No. ______, filed Aug. 17, 2011, and U.S. application Ser. No. ______, filed Aug. 17, 2011.

### BACKGROUND OF THE DISCLOSURE

Obtaining information about a vendor's enterprises may be useful for a vendor. Obtaining information about members of a consumer base may be useful for a vendor. Compensation may aid a vendor in encouraging individuals to collect and/or provide such information.

### SUMMARY

In one aspect, described herein are methods and systems for issuing a market research survey to a consumer based on a physical location of the user. A market research application that executes on a computer, obtains physical location information for a user of a mobile device. In some implementations, the mobile device is remotely located from the computer. The market research application can identify vendors that have a physical location that is proximate to the mobile device's location information. In response to identifying the vendors, one or more market research surveys for the identified vendors are enumerated. At least one of the enumerated market research surveys is transmitted to the user of the mobile device.

In some implementations, the market research application issues a request for the physical location of the mobile device. In response to issuing the request, the market research application receives location information for the physical location of the mobile device. In some implementations, the mobile device receives the request issued by the market research application and responsively queries a location application for location information representative of the physical location of the mobile device. The mobile device, in response to querying the location application, receives location information from the location application and transmits the location information to the market research application executing on the remote computer.

In some implementations, the market research application identifies vendors by using the location information of the mobile device to approximate an address for the mobile device. Upon approximating the address of the mobile device, the market research application enumerates all vendors within a predetermined distance from the approximated address of the mobile device. Enumerating the vendors, in some implementations, includes obtaining the addresses of vendors having a predetermined zip code from a vendor database. For each obtained address, the market research application determines the distance from the obtained address to the approximated address of the mobile device. Upon determining the distances, the market research application selects a subset of the enumerated vendors based on the determined distances.

The market research application, in some implementations, obtains location information by obtaining the coordinates of the mobile device. In some implementations, the market research application enumerates one or more market research surveys by querying a database for market research surveys associated with the identified vendors.

In another aspect, described herein are methods and systems for presenting a consumer reward program to a consumer based on a physical location of the consumer. A rewards program application executing on a computer, obtains the physical location information for a user of a mobile device. In some implementations, the mobile device is remotely located from the computer executing the rewards program application. The rewards program application can identify consumer rewards programs that are associated with vendors that have a physical location that is proximate to the mobile device location information. Upon identifying the consumer rewards programs the rewards program application can enumerate one or more consumer rewards programs, and can transmit a list of the consumer rewards programs to the user of the mobile device.

In one implementation, the rewards program application issues a request for the physical location of the mobile device. In response to issuing the request, the rewards program application receives location information for the physical location of the mobile device. In some implementations, the mobile device receives the request issued by the rewards program application and responsively queries a location application for location information representative of the physical location of the mobile device. The mobile device, in response to querying the location application, receives location information from the location application and transmits the location information to the rewards program application executing on the remote computer.

In some implementations, the rewards program application identifies vendors by approximating an address for the mobile device using the location information of the mobile device. Upon approximating the address of the mobile device, the rewards program application enumerates all vendors within a predetermined distance from the approximated address of the mobile device. Enumerating the vendors, in some implementations, includes obtaining the addresses of vendors having a predetermined zip code from a vendor database. For each obtained address, the rewards program application determines the distance from the obtained address to the approximated address of the mobile device. Upon determining the distances, the rewards program application selects a subset of the enumerated vendors based on the determined distances.

The rewards program application, in some implementations, obtains location information by obtaining the coordinates of the mobile device. In some implementations, the rewards program application enumerates one or more consumer rewards programs by querying a database for consumer rewards programs associated with the identified vendors.

In some aspects, the present disclosure describes a method. The method may include receiving a location associated with a user and a mobile device. The method may also include determining a research program for a vendor based at least in part on the location. The method may also include sending information about the research program to the mobile device. The method may also include receiving a request for participation in the research program. The method may also include sending at least one inquiry associated with the research program to the mobile device. The method may also include receiving a response to the at least one inquiry from the mobile device.

Receiving the location may include receiving coordinates associated with the mobile device. Determining the research program may include retrieving a location of an enterprise associated with the vendor; comparing a threshold with a distance between the location associated with the mobile device and the location of the enterprise; and selecting the research program for the vendor when the threshold exceeds the distance. Determining the research program may include selecting a plurality of research programs for vendors with enterprises located within a threshold distance of the location associated with the mobile device; sorting the plurality of research programs based at least in part on distances between the location of the mobile device and locations of the enterprises; and selecting a subset of the plurality of research programs based at least in part on the distances. Determining the research program may include determining the research program based at least in part on information about the user, demographic information about the user, and/or the user's participation in research programs. Determining the research program may include determining an amount of compensation for participating in the research program.

Sending the information about the research program may include sending an identity of the vendor and a description of the research program. Sending the information about the research program may include sending an identity of the vendor, a description of the research program, and information about an amount of compensation for participating in the research program. Sending the at least one inquiry associated with the research program may include sending a first inquiry to the mobile device; and sending a second inquiry to the mobile device.

Receiving the response to the at least one inquiry may include receiving a first response to a first inquiry associated with the research program; and receiving a second response to a second inquiry associated with the research program. Receiving the response to the at least one inquiry may include determining acceptability of the response. The method may also include increasing an account of the user by an amount of compensation.

In some aspects, the present disclosure may be directed to a method. The method may include receiving a request to access at least one research program for a vendor. The method may also include determining a location of the mobile device. The method may also include sending the location to a server. The method may also include receiving information about a research program from the server, the research program based at least in part on the location. The method may also include receiving a request for participation in the research program. The method may also include sending the request for participation to the server. The method may also include receiving at least one inquiry associated with the research program.

Determining the location of the mobile device may include receiving signals from positioning satellites and determining the location from the signals. Determining the location of the mobile device may include receiving coordinates associated with the location of the mobile device. Receiving the information about the research program may include displaying an identity of the vendor, a location of an enterprise associated with the vendor, a description of the research program, and information about an amount of compensation for participating in the research program. The method may also include sending a response to the at least one inquiry to a server.

In some aspects, the present disclosure may be directed to a method. The method may include receiving a location associated with a user and a mobile device. The method may also include determining a research program for a vendor based at least in part on the location. The method may also include determining compensation for the user for participating in the research program. The method may also include sending information about the research program and the compensation to the mobile device.

Receiving the location may include receiving coordinates associated with the mobile device. Determining the research program may include retrieving a location of an enterprise associated with the vendor; comparing a threshold with a distance between the location associated with the mobile device and the location of the enterprise; and selecting the research program for the vendor when the threshold exceeds the distance. Determining the research program may include selecting a plurality of research programs for vendors with enterprises located within a threshold distance of the location associated with the mobile device; sorting the plurality of research programs based at least in part on distances between the location of the mobile device and locations of the enterprises; and selecting a subset of the plurality of research programs based at least in part on the distances.

Determining the research program may include determining the research program based at least in part on information about the user. Determining the research program may include determining the research program based at least in part on the user's participation in research programs. Determining the compensation may include determining the compensation based at least in part on demographic information about the user.

The method may also include receiving a response to at least one inquiry associated with the research program from the mobile device; and determining acceptability of the response. The method may also include increasing an account of the user based at least in part on the compensation and the acceptability of the response. The method may also include re-sending the at least one inquiry to the mobile device based on the acceptability of the response. In some aspects, the present disclosure is directed to a method. The method may include receiving a request to access at least one research program for a vendor. The method may also include determining, by the mobile device, a location of the mobile device. The method may also include sending the location to a server. The method may also include receiving information about a research program associated with a vendor from the server. The research program may be based at least in part on the location. Information about the research program includes compensation for participating in the research program. The method may also include displaying the information about the research program.

Determining the location may include receiving signals from positioning satellites, and determining the location from the signals. Determining the location of the mobile device may include determining coordinates of the mobile device. Displaying the information about the research program may include displaying an identity of the vendor, a description of the research program, and/or information about the compensation. Displaying the information about the research program may include displaying a distance between the location associated with the mobile device and a location of an enterprise associated with the vendor.

The method may also include sending a response to an inquiry associated with the research program; and receiving a message that the response has been rejected by the research program.

In some aspects, the present disclosure is directed to a method. The method may include receiving a location associated with a mobile device. The method may also include determining at least one offer to complete at least one task based at least in part on the location. The method may also include sending the at least one offer to the mobile device. The method may also include receiving a selection of an offer by a user of the mobile device. The method may also include sending a request for data associated with the selection of the offer. The method may also include receiving data associated with the request from the mobile device. The method may also include determining acceptability of the data. The method may also include allocating compensation to the user according to the acceptability of the data.

Receiving the location may include receiving coordinates corresponding to the location and/or receiving an address corresponding to the location. Determining the at least one offer may include determining the at least one offer based at least in part on a distance between the location associated with the mobile device and a location of an enterprise for a third party associated with the at least one offer. Determining the at least one offer may include determining the at least one offer based at least in part on a profile of the user of the mobile device.

Sending the request for data may include sending the request for information associated with a task. Receiving the data associated with the request may include receiving at least one of an image, a video file, and a response to a question. Determining the acceptability of the data may include determining a number of completed tasks and a number of uncompleted tasks according to the data associated with the request; and determining the number of completed tasks exceeds a threshold number of tasks. Determining the acceptability of the data may include determining a period of time between display of the request for data on the mobile device and receipt of the data associated with the request falls below a threshold of time. Determining the acceptability of the data may include determining a distance between a location of the mobile device when sending the data associated with the request and a location of an enterprise for a third party falls below a threshold distance.

The location of the mobile device when sending the data associated with the request may be a location associated with at least one of an image or a video file. Allocating the compensation to the user may include increasing an amount in an account associated with the user. The method may also include sending a notification to the mobile device that the at least one offer can be selected when a distance between the location of the mobile device and a location of an enterprise for a third party falls below a threshold.

In some aspects, the present disclosure is directed to a method. The method may include determining a location associated with the mobile device. The method may also include sending the location to a server. The method may also include receiving at least one offer from a third party to complete a task based at least in part on the location. The method may also include sending a selection of an offer. The method may also include receiving a request for data associated with the selection. The method may also include sending data associated with the request. The method may also include receiving a notification of compensation based at least in part on acceptability of the data.

Determining the location may include receiving signals from positioning satellites; and determining the location based on the signals. Determining the location may include triangulating signals received from positioning satellites. Sending the data associated with the request may include sending at least one of an image, a video file, and a response to a question.

### BRIEF DESCRIPTION OF THE DRAWINGS

The following figures depict certain illustrative implementations of the methods and systems described herein, where like reference numerals refer to like elements. Each depicted implementation is illustrative of the methods and systems and not limiting.

FIGS. 1 and 2 are block diagrams of exemplary computing devices usable in the systems of FIGS. 3 and 10;

FIG. 3 is a block diagram of an exemplary system for selecting and processing offers to complete tasks;

FIGS. 4 and 5 are flow diagrams of exemplary methods for selecting and processing offers to complete tasks;

FIGS. 6-9 include exemplary user interfaces for selecting and processing offers to complete tasks;

FIG. 10 is a block diagram of an exemplary system for deploying a location based market research program and/or a location based rewards program;

FIG. 11 is a flow diagram of an exemplary method 1100 determining the location of a user of a mobile device;

FIG. 12 is a flow diagram of an exemplary method for identifying and transmitting market research surveys to a mobile device;

FIG. 13 is a flow diagram of an exemplary method for identifying consumer rewards programs located near a mobile device;

FIG. 14 is a flow diagram of an exemplary method for selecting and processing a research program;

FIG. 15 is a flow diagram of an exemplary method for selecting and processing a research program;

FIG. 16 is a flow diagram of an exemplary method for determining a research program and compensation for a user;

FIG. 17 is a flow diagram of an exemplary method for determining research programs and compensation for a user; and

FIGS. 18 and 19 include exemplary user interfaces for selecting and processing research programs and compensation.

### DETAILED DESCRIPTION

The methods, systems and apparatus described herein are not limited to the specific devices, methods, applications, conditions or parameters described and/or shown herein. It is to be appreciated that certain features of the methods, systems and structures described herein are described in the context of separate implementations, and may be provided in any combination or sub-combination of the implementations described herein. Furthermore, any reference to values stated in ranges includes each and every value within that range.

The following terminology is used throughout this disclosure:

As used herein, a “user” can be, in some implementations, a user of a mobile device 1050 where the user can execute applications on the mobile device 1050 and participate in surveys and reward programs presented to the user via the mobile device 1050. In some instances, the user can be a consumer of goods.

As used herein, “market research” can be, in some implementations, information obtained from a consumer that can be used to determine the needs, size and competitors in a market.

As used herein, a “rewards program” can be, in some implementations, a program that provides rewards to a consumer when that consumer behaves in a particular manner. The rewards can be any of the following: discounts; rebates; points; free items; or any other reward. In some implementations, a rewards program fosters loyalty between the consumer and the vendor that provides the reward. In some implementation the rewards program can be referred to as a consumer rewards program.

As used herein, a “mobile device location” can be the location of a mobile device 1050 on a coordinate map. In some implementations, the location can be a set of coordinates such as a set of Cartesian coordinates.

As used herein, a “vendor” can be a third party that produces or provides a product or a service. In some implementations, the vendor can interact with a market research application 220 or rewards program application 1035 to provide consumers with rewards and/or to obtain information about a consumer's behavior with regard to the vendor's product/service.

In general overview, the present disclosure is directed to, among other things, obtaining information regarding a vendor's enterprise, obtaining information regarding a user, and/or compensating a user for providing the information, based on the user's location. From a mobile device, a user may request to receive offers to complete tasks on behalf of vendors. The mobile device may send the request and the device's location to a server. A server may receive the request and determine at least one offer to complete tasks on behalf of a vendor based at least in part on the location. The server may determine an amount of compensation for completing the tasks. The mobile device may display descriptions of the offers and compensation to the user. Upon user selection of an offer, the server may send the mobile device tasks, and the user may provide information in response to the tasks. The server may determine if the information for acceptability and/or allocate the compensation to the user if the information is acceptable. The server may perform similar steps for market research programs.

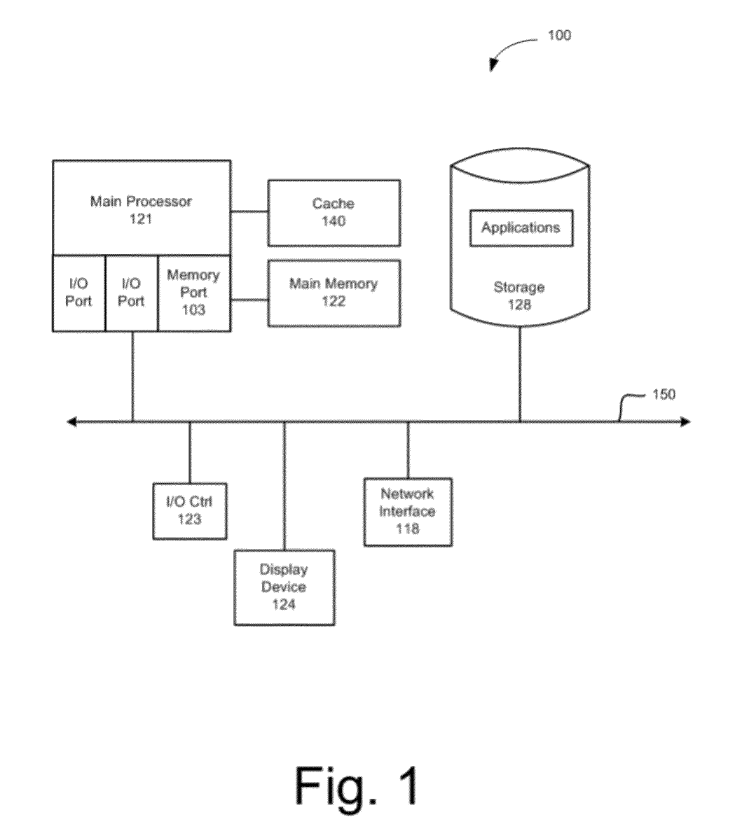

Illustrated in FIG. 1 is one implementation of a computing device 100 such as any computing device described herein. Computing device 100 can include a central communication bus 150 that communicates with each of the components included in the computing device 100. These components can include: an input/output (I/O) control 123; a display device 124; a network interface 118; a storage repository 128; a main processor 121; cache 140; and memory 122. The main processor 121 can include elements such as one or more I/O ports, or a memory port 103.

Further referring to FIG. 1, and in more detail, in some implementations the computing device 100 can be any computing device 100 having a processor 121. The computing device 100 can be a mobile device such as a laptop, netbook, smart phone, electronic reader, cell phone, personal digital assistant, tablet computer or any other hand-held computing device comprising a processor 121. In some implementations, the computing device 100 can be any hand-held mobile device able to carry out the methods and systems described herein. In some implementations, the computing device 100 can be a computer, a client computer, a server, or any other machine comprising a processor 121 able to execute computer readable instructions. The computing device 100, in some implementations, can be referred to as a computer, a computing machine, a machine, a device, a mobile device, or a mobile device.

The processor 121 included in the computing device 100 can be referred to as a central processing unit (CPU) or as a main processor. In some implementations, the processor 121 can include a single processing core, while in some implementations the processor 121 can include multiple processing cores. When the processor 121 includes multiple processing cores, the cores can execute in parallel and can access a shared memory location or individual memory locations assigned to particular cores. In some implementations, the computing device 100 can include multiple processors 121. When the processor 121 includes multiple processing cores or multiple processors, the processors can execute a single instruction simultaneously on multiple pieces of data (SIMD), or in some implementations can execute multiple instructions simultaneously on multiple pieces of data (MIMD).

In one implementation, the processor(s) 121 can be any processor. In some implementations, the processor(s) 121 can be any combination of a microprocessor, a microcontroller, programmable logic gates, or any other processor. The processor 121, in some implementations, can further comprise a graphics processing unit (GPU) which can include any combination of hardware and processor-executable instructions for processing graphics data and graphics commands. In some implementations, the processor 121 can further comprise a graphics engine or any other processing engine.

I/O ports can be included on the processor(s) 121 and can be used to interface with I/O controllers 123 and I/O devices. These I/O devices can include display devices 124, keyboards, mice, pointers, printers, microphones, other computing machines, speakers, or any other I/O device. In some implementations the I/O devices can communicate with the computing device 100 via the I/O controller 123, while in some implementations the I/O controller 123 can be used to communicate and control the I/O device. The I/O device, in some implementations, can function as a communication bus that establishes communication between an external device or computer and the computing device 100. For example, the I/O device can be any of the following buses: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus. In another implementation, the I/O device can be an external storage unit such as flash memory or a hard drive. When the I/O device is a display device 124, the display device 124 can be any display device including an integrated display or an external monitor or other similar display device.

The processor 121 can interface with any number of memory elements or storage repositories. In some implementations the processor 121 can interface with cache memory 140 which can be any cache memory 140 and in some implementations can be static random access memory (SRAM), dynamic random access memory (DRAM), enhanced DRAM, or any other type of memory. Similarly the main memory unit 122 can be any type of memory. The processor 121 can interface and interact with the main memory 122 and any other memory unit via a system bus 150, a memory port 103 or any other connection. The processor can further access any storage repository 128 or additional memory location. In some implementations, the processor 121 can access any application or data stored in the storage repository 128. The processor 121, in some implementations, accesses a stored application to execute that application.

The computing device 100, in some implementations, can execute an operating system. In some implementations, the operating system can be any operating system, while in some implementations the operating system can be any embedded operating system for a mobile device. In some implementations, the computing device 100 can execute multiple operating systems.

A network interface 118 can be included in the computing device 100 and can be used to interface with any network. In some implementations, the network interface 118 can communicate over a local area network (LAN), a wide area network (WAN), a wireless network, or any other network. The network interface 118, in some implementations, can be a built-in network adapter; a network interface card; a PCMCIA network card; a card bus network adapter; a wireless network adapter; a USB network adapter; a modem; or any other device suitable for interfacing the computing device 100 to a network.

The systems, software, and methods described herein can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired. In any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits).

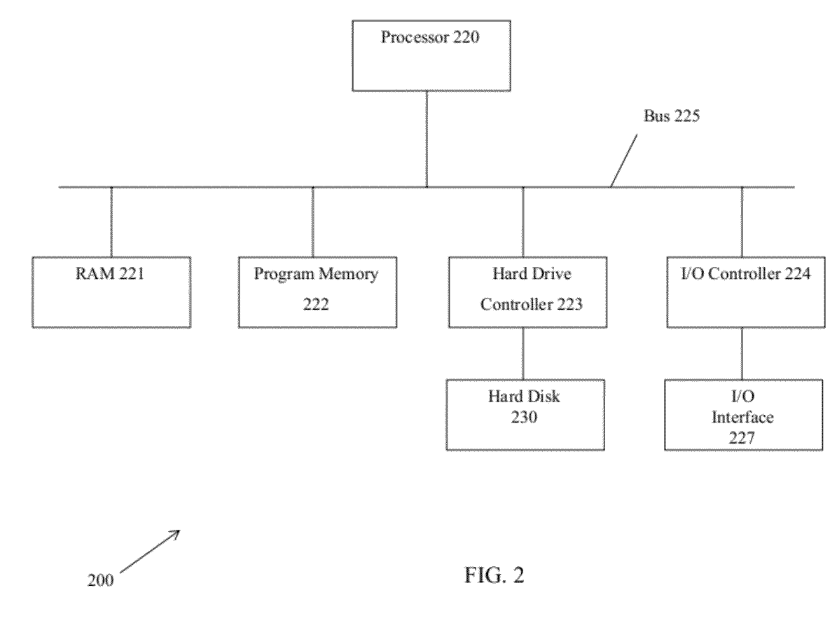

An example of one such type of computer is shown in FIG. 2, which shows a block diagram of a programmable processing system (system) 211 suitable for implementing or performing the apparatus or methods described herein. The system 211 includes a processor 220, a random access memory (RAM) 221, a program memory 222 (for example, a writeable read-only memory (ROM) such as a flash ROM), a hard drive controller 223, and an input/output (I/O) controller 224 coupled by a processor (CPU) bus 225. The system 211 can be preprogrammed, in ROM, for example, or it can be programmed (and reprogrammed) by loading a program from another source (for example, from a floppy disk, a CD-ROM, or another computer).

The hard drive controller 223 is coupled to a hard disk 230 suitable for storing executable computer programs, including programs embodying the present methods, and data including storage. The I/O controller 224 is coupled by an I/O bus 226 to an I/O interface 227. The I/O interface 227 receives and transmits data in analog or digital form over communication links such as a serial link, local area network, wireless link, and parallel link.

Elements of different implementations described herein may be combined to form some implementations not specifically set forth above. Some implementations not specifically described herein are also within the scope of the claims.

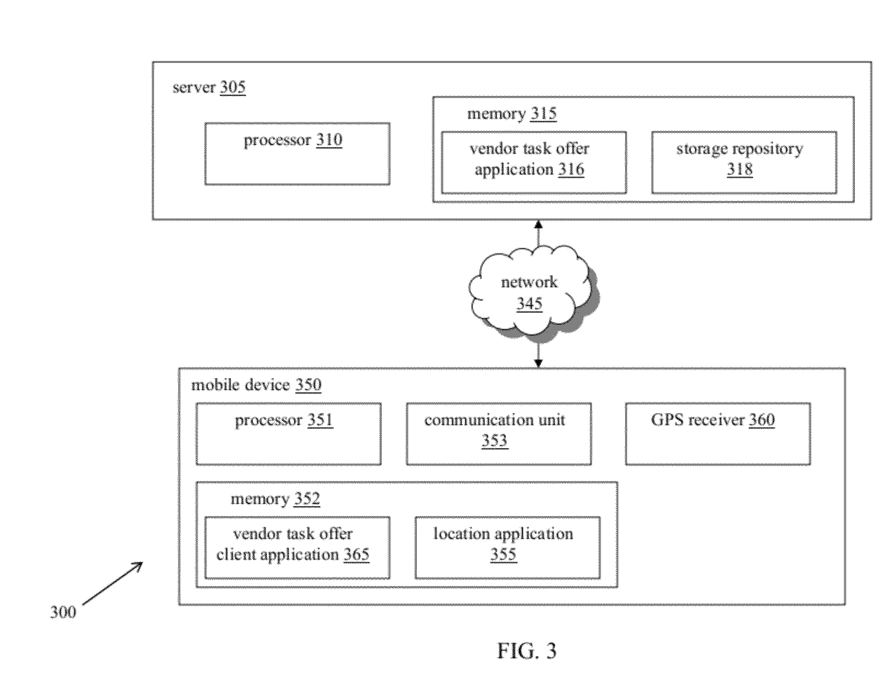

Referring now to FIG. 3, a system 300 for selecting and processing offers to complete tasks is shown and described. The system 300 includes a server 305 in communication over a network 345 with a mobile device 350. The server 305 may include a processor 310. The server 305 may include a memory 315. In some implementations, the memory 315 may store instructions for execution. For example, the memory 315 may store instructions for a vendor task offer application 316. In some implementations, the memory 315 may include a storage repository 318. For example, the memory may store offers to complete tasks (also referred to herein as “task offers”). Each offer may be associated with a third party, such as a vendor.

The mobile device 350 may include a processor 351 and a memory 352. The memory 352 may include instructions that, when executed by the processor 351, cause the mobile device 350 to operate according to any of the functions described herein. For example, the memory may include instructions for a vendor task offer client application 365. The mobile device 350 may include a communication unit 353. In some implementations, the communication unit 353 may communicate with cellular networks and/or computer networks. In some implementations, the mobile device 350 may include a location application 355. In some implementations, the mobile device 350 may include a Global Positioning System (GPS) receiver 360.

The memory 352 of the mobile device 350 may include a vendor task client application 365. In some implementations, mobile device 350 may include an application in which selecting and processing task offers may be a function and/or subapplication. In some implementations, a user may obtain the vendor task client application 365 from a website (e.g., download the application). In some implementations, the user may obtain the vendor task client application 365 at a centralized location for marketing mobile device 350 applications. Purchasing and/or requesting the vendor task client application 365 may initiate a download from the centralized location to the mobile device 350.

In operation, a user of the mobile device 350 may request a display of at least one offer to complete one or more tasks. In some implementations, the user may make the request by opening the vendor task client application 365 on the device 350. For example, the user may open the application 365 by selecting an icon on the device's 350 touchscreen. In another example, the user may open the application 365 by accessing the application 365 via a menu and/or control panel. The application 365 may require the user to enter credentials (e.g., username, password). In some implementations, the user may make the request by accessing a function of an open application. The user may navigate through an open application's menu to access the function that requests offers to complete tasks. The user may select a tab for an open application to access the function. In response to the user's request, the mobile device 350 may determine the device's location. In some implementations, a location application 355 and/or a GPS receiver 360 may determine the location based on messages from GPS satellites. The GPS receiver 360 may receive the messages. The messages may include at least the time the signal was transmitted and/or orbital information about the satellite(s). The location application 355 may use the information in the messages to determine distances to each of the satellites. The location application 355 may use the distances and the satellites' locations to determine the device's 350 location. In some implementations, the location application 355 may use triangulation to determine the location.

In some implementations, the location application 355 may use telecommunication signals to determine the device's 350 location. The location application 355 may use messages from cellular networks to determine the location. In some implementations, the location application 355 may connect to any data networks meeting the International Mobile Telecommunications-2000 (IMT-2000) standards (e.g., 3G, 4G). The location application 355 may use any information from signals transmitted via the networks to determine the device's 350 location.

In some implementations, the location application 355 may use signals from computer networks to determine the device's 350 location. For example, the location application 355 may connect to a computer network using IEEE 802.11 standards. The location application 355 may connect to a computer network using any standards covered by the Wi-Fi™ standards. The application 355 may use any information from signals transmitted via the computer networks to determine the device's 350 location.

In some implementations, the location may include coordinates. The coordinates may correspond to the device's 350 position on the surface of the earth. The coordinates may include Cartesian coordinates. The location may include coordinates for latitude and longitude. In some implementations, the location may include an address corresponding to the coordinates for the location.

The mobile device 350 may send the location to the server 305. In some implementations, the mobile device 350 may send the username of the user of the device 350. In some implementations, the mobile device 350 may send an identifier of the device 350 (e.g., device serial number). The mobile device 350 may send the version number of the vendor task client application 365. In some implementations, the mobile device 350 may send the model and/or version of the device 350 (e.g., iPhone 4 manufactured by Apple Inc. of Cupertino, Calif.; Droid 3 manufactured by Motorola, Inc. of Schaumberg, Ill.). The mobile device 350 may send any of the information described herein to the vendor task offer application 316 on the server 305. In some implementations, the device 350 may send the information via Representational State Transfer (REST) requests. The device 350 may send the information using Hypertext Transfer Protocol (HTTP).

The server 305 may identify a user based on the username and/or identifier of the device 350. The server 305 may associate the location and the user. In some implementations, the server 305 may retrieve a user profile associated with the user from the storage repository 318. The user profile may include any information about the user. For example, the user profile may include the user's gender, age, income level, city of residence, or any other demographic information. In some implementations, the user profile may include a radius (e.g., a maximum distance between the user and vendors' enterprises for which task offers should be displayed to the user).

In some implementations, the vendor task offer application 316 may identify at least one vendor task offer based on the location of the mobile device 350 and/or the user profile. The application 316 may identify vendors with at least one enterprise (e.g., retail store, franchise) within a threshold distance of the device 350. In some implementations, the application 316 may query the storage repository 318 for task offers associated with vendors with an enterprise within the threshold distance. For example, suppose the threshold distance is 50 feet. The application 316 may determine that Coffee Company A has a coffee store 25 feet from the user. The application 316 may identify the task offer associated with Coffee Company A as a task offer to potentially send to the user. In another example, the application 316 may determine that Bakery B has a franchise within 10 feet of the user. The application 316 may identify the task offer associated with Bakery B as a task offer to potentially send to the user. In another example, the application 316 may determine that Clothing Company C has a retail store within 100 feet of the user. Since the distance is larger than the threshold distance of 50 feet, the application 316 may not identify the task offers associated with the clothing company.

Although the threshold distance used in these examples is 50 feet, other values may be used. In some implementations, threshold distances may be determined based on information in the user profile (e.g., a user setting indicating how far a user may be willing to travel for a task offer). In some implementations, the vendor task offer application 316 may select the threshold distances. For example, the application 316 may include a default threshold distance.

In some implementations, the application 316 may use a threshold distance selected by a vendor. Different vendors may select different threshold distances. For example, the application 316 may determine that Clothing Company D has a retail store within 75 feet of the user. Because Clothing Company D has selected a threshold distance of 100 feet, the application 365 may identify Clothing Company D as a vendor whose task offer may be delivered to the user. In another example, the application 316 may determine that Coffee Company B has a coffee shop within 80 feet of the user. However, because Coffee Company B has selected a threshold distance of 50 feet, the application 316 may not identify Coffee Company B as a vendor whose task offer may be delivered to the user.

In some implementations, the application 316 may identify task offers based on information in the user profile. The profile may include behavioral information about the user. For example, the profile may include a list of vendors for which the user is already a repeat customer. For example, the profile may indicate the user regularly drinks coffee from Coffee Company A, buys suits from Work Clothes Giant, purchases electronics from High Tech Fanatics stores, and eats at Mexican Burritos Unlimited. Using such information, the application 316 may rank task offers for these vendors with enterprises within the threshold distance of the user. The application 316 may rank the task offers according to the vendors from whom the user already makes purchases.

In some implementations, the application 316 may eliminate task offers from consideration according to the user profile. For example, if the profile indicates the user does not consume alcohol, the application 316 may not select task offers associated with retailers for alcoholic beverages. If the profile indicates the user has not yet reached a legal drinking age, the application 316 likewise may not select task offers associated with retailers for alcoholic beverages. In some implementations, the user profiles may indicate the categories of vendors for whom the user would be willing to perform tasks. In some example, the user profile may include task offers previously completed by the user. The user profile may indicate the user has already completed a task offer for Coffee Company A three times. Thus, the application 316 may eliminate task offers associated with Coffee Company A from consideration.

In some implementations, more than one task offer may be associated with a vendor. The application 316 may identify one of the task offers based on the user profile. For example, a vendor may have task offers with different sets of tasks for users with different demographic profiles. The vendor task offer application 316 may identify the vendor's task offer corresponding to the user's demographic profile.

In some implementations, the vendor task offer application 316 may obtain task offers for identified vendors with at least one enterprise within one or more threshold distances of the user. For example, the application 316 may retrieve the task offers from the storage repository 318. In some implementations, the task offer may include an amount of compensation for a user who completes the tasks in the offer. The amount of compensation may be an amount of cash, rewards points for a vendor and/or program, or any other compensation as would be appreciated by one of ordinary skill in the art. In some implementations, the amount of compensation may be a rebate and/or a coupon for a vendor.

The task offer may include a single amount of compensation. The task offer may include different amounts of compensation and conditions associated with each amount. Conditions may include requirements regarding demographic information (e.g., vendors may offer different amounts of compensation to encourage participation from members of demographics for which the vendors may have less information). For example, male users between the ages of 21-34 may be eligible for compensation of $A, whereas male users between the ages of 35-50 may be eligible for compensation of $B. In some implementations, amounts of compensation may vary based on gender, age, ethnicity, residency, income level, or any other factor.

In some implementations, the task offer may include at least one required capability for the user's mobile device 350. For example, if a task in a task offer involves capturing an image, the task offer may require the mobile device 350 to include a camera. In another example, if a task involves scanning a barcode, the task offer may require the mobile device 350 to include a scanner and/or a camera. In another example, if a task involves obtaining an audio file, the task offer may require the mobile device 350 to include a microphone. The application 316 may determine the device's 350 capabilities according to the model and/or version number of the device's 350. In some implementations, the application 316 may select task offers whose requirements may be met by the model and/or version number.

The vendor task offer application 316 may send descriptions of the task offers to the mobile device 305. Each description may include the name of the vendor, the address of the vendor's enterprise, and/or an amount of compensation for completing the tasks requested by the vendor. The vendor task offer client application 365 on the mobile device 305 may receive the descriptions. The mobile device 305 may display a list of the tasks. The user of the device 305 may scroll down the list, by way of example.

The user may select a task offer. In some implementations, the user may select the task offer by touching an area of the device's 350 touch screen associated with the task offer. The user may enter a symbol corresponding to the task offer (e.g., the number of the task in a list). The device 350 may send the selection to the vendor task offer application 316 on the server 305. In some implementations, upon the user selection of the task offer, the location application 355 may obtain the device's 350 location. The location application 355 may send the updated location to the server 305. The vendor task offer application 316 on the server 305 may determine the user remains within a threshold distance of the enterprise before sending the requests of the task offer to the mobile device 350.

In some implementations, the application 316 may obtain the first request for data of the task offer. The application 316 may process the first request for data for display on the mobile device 305. For example, the application 316 may create a user interface presenting the request for data. The application 316 may send the user interface to the mobile device 350 for display thereon.

Exemplary requests for data may include requests for the user to perform an act and provide information regarding the enterprise's response to the act. For example, the request may ask the user to enter a retail store and indicate how promptly a sales clerk offered assistance (e.g., measure the time that elapses, provide a “yes/no” response regarding the promptness). The request may ask the user to request service from a sales clerk in a retail store and describe the clerk's behavior. A request may ask the user to ask a grocery store employee for a location of an item and indicate if the employee's answer is accurate. A request may ask the user to order a cappuccino in a coffee shop and measure the time between order and delivery of the beverage. A request may ask the user a question regarding the cleanliness of visible work surfaces in a sandwich shop.

A request may ask the user to capture an image of himself or herself in front of the enterprise to verify the user is at the location. A request may ask the user to purchase an item and capture an image of the item. A request may ask the user to enter the enterprise's public bathroom and capture an image of the facilities. A request may ask the user to capture an image of the shelves at the retail outlet. A request may ask the user to capture an image of the window display at the retail outlet. A request may ask the user to order a drink and capture an image of the drink, the receipt, or the user holding the drink and/or receipt. A request may ask the user to scan a barcode for merchandise at a retail outlet. A request may ask the user to capture an image of the kitchen counter at a diner. The request may ask the user to request service from a sales clerk in a retail store and capture an audio file of the clerk's response.

The user may answer a question in the request, upload a captured image and/or audio file, scan a bar code, or prepare any other data in the request. In some implementations, the user interface may include an input field through which the user may indicate that data cannot be obtained (e.g., a request asks for an image of the restaurant's bathroom, but the facilities have been unavailable for 15 minutes). Through the interface, the user may explain why data cannot be obtained.

In some implementations, the vendor task client application 365 measures a period of time that elapses between display of the request in the user interface and the user's completed preparation of the data. In some implementations, the application 365 may append a time and/or date of capture to an image or audio file. In some implementations, the location application 355 may determine the mobile device's 350 location at the time of capture. The device 350 may append the data with the location (e.g., geo-tag and/or geo-code the data).

The mobile device 350 may submit the data to the vendor task offer application 316 on the server 305. The vendor task offer application 316 may determine the acceptability of the data. The application 316 may determine if the period of time that elapsed between display of the request in the user interface and the user's preparation of the data exceeds a threshold. If the period of time does not, the application 316 may determine the data is unacceptable. Thus, the application 316 may contemplate situations in which the user has provided a cursory and/or unserious response to the data (e.g., a user is nominally performing tasks to obtain the compensation). The application 316 may determine the credibility of a user indication that data cannot be obtained (e.g., the user has waited 30 seconds for the restaurant's bathroom to become available, but the user has claimed to have waited 15 minutes).

In some implementations, the vendor task offer application 316 may determine the quality of the data. For example, the application 316 may determine whether an image file, an audio file, and/or a file with a scanned bar code are uncorrupted. In some examples, the application 316 may analyze the quality of the data. The application 316 may determine if a captured image is in focus. The application 316 may determine if a captured image is sufficiently bright so as to see the image's subjects. The application 316 may determine if a captured image includes the subjects of the request (e.g., whether the user simply took a picture of the floor). The application 316 may determine if a captured audio file includes static. The application 316 may determine if a length of the audio file matches the length included in the request for data.

In some implementations, the vendor task offer application 316 may determine if the user's location when preparing the data is within a threshold distance of the enterprise. For example, the user may have purportedly captured an image of a retail store's window display. However, if the location in the image's geo-tag indicates the user was 150 feet away from the retail store during image capture, the application 316 may determine the image is unreliable.

In some implementations, the vendor task offer application 316 may notify the mobile device 350 that the data is unacceptable. The application 316 may send the device 350 a notification for display. In some implementations, the vendor task offer client application 365 on the mobile device may process the notification. The client application 365 may display a request for a resubmission of data. In some implementations, the application 365 may not request a resubmission of data. In some implementations, if data is unacceptable because the user is providing nominal data, the vendor task offer application 316 may determine the user is an uncredible source of data and terminate the task offer.

The vendor task offer application 316 may obtain the next request for data of the task offer. The application 316 may create a user interface presenting the next request and send the user interface to the mobile device 350. The user may obtain and submit the data to the vendor task offer client application 356, according to any of the steps described herein. The applications 316, 365 may perform any of the steps described herein for each request for data in the task offer.

The vendor task offer application 316 may determine whether the amount of compensation should be allocated to the user. The application 316 may determine the compensation should be allocated when all the received data from the user is acceptable. The application 316 may determine the compensation should be allocated when a threshold number and/or percentage of user submitted data is acceptable. For example, if the user provided five acceptable responses to requests for data but a submitted audio file has some static, the application 316 may determine the user nevertheless submitted a satisfactory amount of data. In some implementations, the application 316 may determine compensation should not be allocated when the application 316 determines the user is uncredible (e.g., when the application 316 terminates the task offer prior to completion of all the tasks).

The application 316 may increase an account associated with the user by the amount of compensation. The application 316 may send a notification to the mobile device 350 indicating the amount of compensation for completing the task offer will be added to the user's account. In some implementations, the application 316 may include a lottery system. For example, the application 316 may randomly select users to receive bonus amounts of compensation. Thus, 1% of the users may receive twice the amount of compensation in the task offer.

In some implementations, the vendor task client application 365 may not display an amount of compensation. Compensation may be allocated according to a lottery and/or sweepstakes system. For example, one (1) out of every hundred (100) people who complete the task offer may receive a larger amount of compensation (e.g., $100), although other percentages and/or ratios may be used.

In some implementations, the vendor task offer application 316 may send all the user interfaces for all the requests for data in a task offer to the mobile device 350. The mobile device 350 may store and display the user interfaces to the user. The user may navigate through the user interfaces, and the mobile device 350 may store each data prepared by the user. Once the user has provided data for all the requests, the mobile device 350 may send all the data to the vendor task offer application 316 together. The application 316 may determine the acceptability of the data according to any of the steps described herein.

In some implementations, the mobile device 350 may store data from the user if the device 350 cannot communicate with the server 305 (e.g., insufficient signal strength from the cellular network, interruptions in service in a telecommunications network). The user may continue navigating through the user interfaces and preparing data. The mobile device 350 may determine that communication with the server 305 has resumed. The mobile device 350 may submit the stored data provided by the user to the vendor task offer application 316.

In some implementations, the vendor task offer application 316 may identify a task offer associated with a vendor with an enterprise that is not within a threshold distance of the device 350. The application 316 may notify the user that the task offers may become available once the user moves within the threshold distance to the enterprise.

In some implementations, the vendor task offer application 316 may establish a communication channel between the mobile device 350 and the vendor of the selected task offer. For example, the application 316 may establish an instant messaging session or video chat session between personnel for the vendor and the mobile device 350. The personnel may send the user requests for data in real-time. In some implementations, personnel may determine the acceptability of data from the user and/or request resubmission of data. The personnel may determine if the user is a credible source of data.

In some implementations, the vendor task client application 365 may be embedded in an application for a third-party. For example, a social media organization may embed the vendor task application into its own application for mobile devices. Thus, when the social media organization's application is open and/or active, the vendor task client application 365 receive task offers from the vendor task offer application 316 to present to the user. In some implementations, the compensation for completing task offers may be a form of currency usable on through social media organization. For example, the compensation may be virtual points usable at the organization's site.

In another example, a game application may embed the vendor task client application 365 into its own mobile device application. Compensation for completing task offers may be a form of currency applicable to the game. For example, if the game application requires a subscription, the compensation may be payment covering the subscription for a predetermined period of time (e.g., day, week, month). In some examples, compensation may be an item usable in the game (e.g., “lives” to continue playing the game, virtual currency to purchase items used in the game). Various organizations may embed the vendor task offer client application 365 into their own mobile applications, as would be appreciated by one of ordinary skill in the art.

In some implementations, the user may download a vendor task offer client application 365 without registering with the vendor task service. When the server 305 determines the user has submitted satisfactory data for a task offer, the vendor task offer client application 365 may require the user to register. The user may provide identification information and/or create credentials for the account. The vendor task application may apply the amount of compensation for completing the ask offer to the user's account.

In some implementations, while the vendor task offer client application 365 is active, the location application 355 may determine the device's 350 location on a periodic basis (e.g., once every 3 minutes, 10 minutes). The location application 355 may send the updated location to the vendor task offer application 316 on the server 305. The vendor task offer application 316 may determine task offers available within the threshold distance(s) of the updated location. The vendor task offer application 316 may send descriptions of the updated task offers to the mobile device 350 for display.

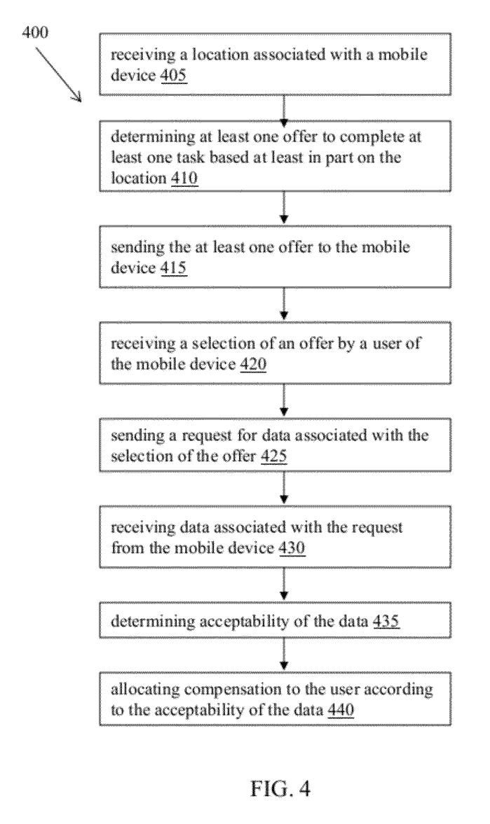

Referring now to FIG. 4, a flow diagram 400 of an exemplary method for selecting and processing offers to complete tasks is shown and described. The method may include receiving a location associated with a mobile device (step 405). A server 305 may receive the location. The location may include coordinates. The location may include an address. The server 305 may direct the location to a vendor task client application 365. In some implementations, the server 305 may receive an identity of a user with the location. The server 305 may receive a username of the user.

The method may include determining at least one offer to complete at least one task based at least in part on the location (step 410). In some implementations, a vendor task offer application 316 may query a storage repository 318 for task offers associated with vendors with at least one enterprise located within a threshold distance of the mobile device 350. The application 316 may determine a distance between the location associated with the mobile device and a location of an enterprise for a third party associated with the at least one offer. The application 316 may compare the distance with a threshold. If the threshold exceeds the distance, the application 316 may select the task offer as an offer to send to the user at the mobile device 350.

In some implementations, the vendor task offer application 316 may determine the at least one offer based at least in part on a profile of the user of the mobile device. The server 305 may retrieve the user profile for the storage repository 318. The server 305 may identify task offers based on behavioral information about the user. For example, the server 305 may identify task offers associated with vendors for whom the user is already a repeat customer. The server 305 may identify a task offer directed to users in the user's demographic group. The server 305 may identify a task offer based on user profile information according to any method described herein.

The method may include sending the at least one offer to the mobile device (step 415). The server 305 may create a user interface presenting descriptions of each task offer to send to the user. The description may include an identity of the vendor, an address for the vendor's enterprise, and/or an amount of compensation for completing the task offer.

The method may include receiving a selection of an offer by a user of the mobile device (step 420). The method may include sending a request for data associated with the selection of the offer (step 425). In some implementations, the request for data may include a request for information associated with a task. The server 305 may create a user interface including the request for data. The server 305 may create a user interface including a request for information associated with the task. The requests may be any of the requests described herein. The server 305 may send the user interface for display on the mobile device 350.

The method may include receiving data associated with the request from the mobile device (step 430). In some implementations, the data associated with the request may be an image, a video file, an audio file, and/or a response to a question. The data may be any of the data described herein. In some implementations, the data may include the time, date, and location where the data had been captured.

The method may include determining acceptability of the data (step 435). Acceptability of the data may be determined based on the quality of an image (e.g., focus, brightness, identification of desired subjects) or the quality of an audio file (e.g., volume, amount of static), by way of example. Acceptability of the data may be determined based on the distance between the enterprise associated with the vendor and the location where the data was captured and/or the location of a mobile device 350 when the data was sent. If the distance falls below a threshold, the vendor task offer application 316 may determine that the data is acceptable. In some implementations, acceptability may be determined based on the period of time that elapsed between display of the request for data on the mobile device and the capture of the data and/or sending of the data to the server 305.

In some implementations, the vendor task offer application 316 may determine a task has been completed if the data for the task is acceptable. The application 316 may compare a number of completed tasks and a number of uncompleted tasks. In some implementations, the application 316 may determine a percentage of completed tasks, for the total number of tasks in the task offer. In some implementations, a task offer may require a predetermined number of completed tasks or a predetermined percentage of completed tasks.

The method may include allocating compensation to the user according to the acceptability of the data (step 440). If the number of completed tasks equals or exceeds the predetermined number of completed tasks required by the task offer, the vendor task offer application 316 may determine the user should receive compensation for the task offer. If the percentage of completed tasks equals or exceeds the predetermined percentage required by the task offer, the application 316 may determine the user should receive compensation for the task offer. The application 316 may increase increasing an amount in an account associated with the user.

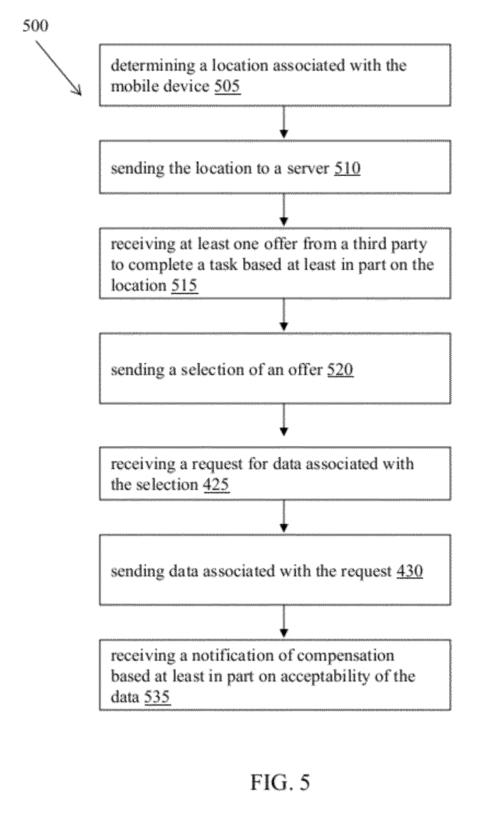

Referring now to FIG. 5, a flow diagram 500 of an exemplary method for selecting and processing offers to complete tasks is shown and described. The method may include determining a location associated with the mobile device (step 505). A mobile device 350 may determine its location in response to a user request for task offers. A location application 355 on the device 350 may determine the location based on signals received from GPS satellites. The location application 355 may triangulate the signals to determine the device's 350 location. The location application 355 may use signals from a computer network and/or a cellular network to determine the device's 350 location.

The method may include sending the location to a server (step 510). The mobile device 350 may also an identity of the user (e.g., username). The mobile device 350 may send a serial number of the device, from which a vendor task application on the server 305 may identify the user. The method may include receiving at least one offer from a third party to complete a task based at least in part on the location (step 515). The method may include sending a selection of an offer (step 520). The selection may be based on a user touching an area of the device's 350 touch screen corresponding to the offer. The selection may be based on the user inputting a symbol corresponding to the offer (e.g., the number of the offer in a list of task offers).

The method may include receiving a request for data associated with the selection (step 525). The request for data may be presented in a user interface and displayed on the mobile device's 350 display. The request for data may be any of the requests described herein. The method may include sending data associated with the request (step 530). The mobile device 350 may send to the server 305 any of the data described herein. The method may include receiving a notification of compensation based at least in part on acceptability of the data (step 535). The notification may include a message that an addition of the amount of compensation for the task offer to the user's account may be pending.

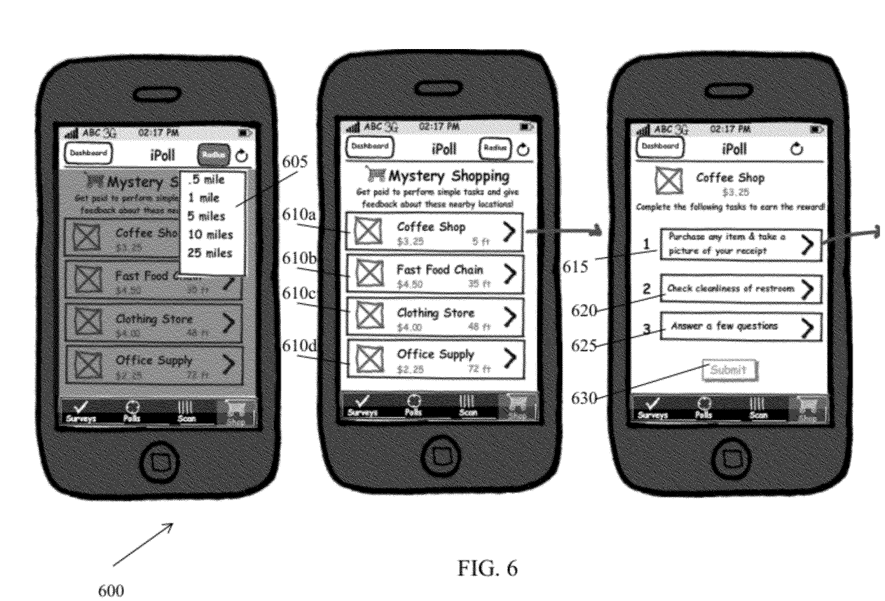

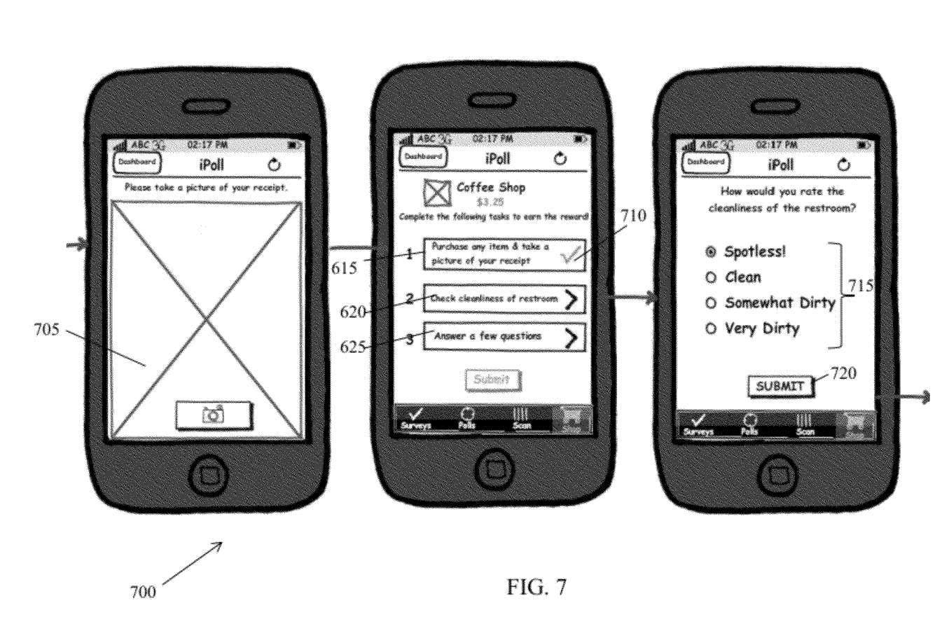

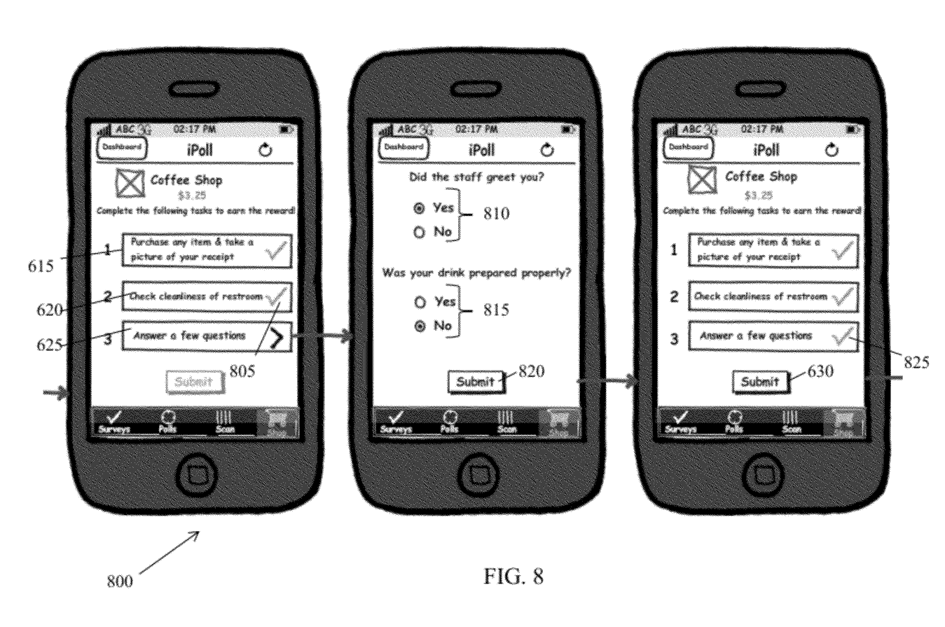

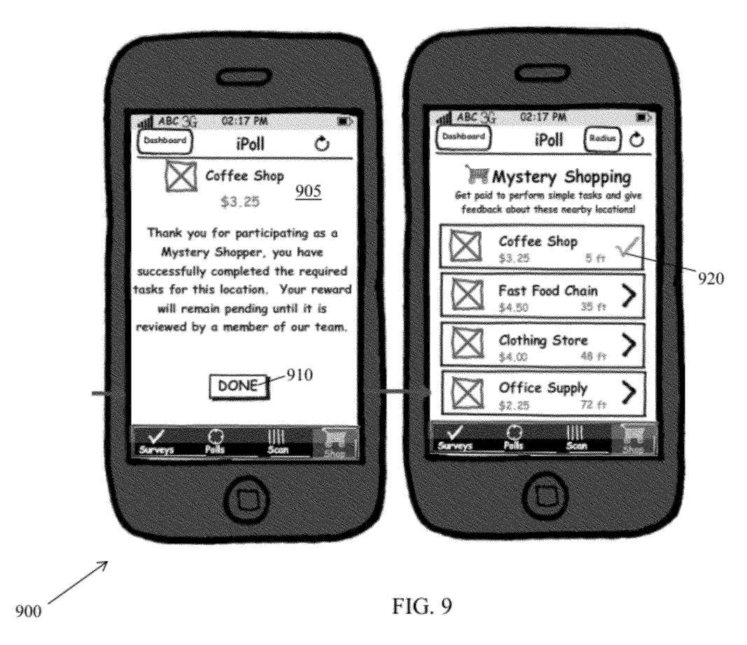

Referring now to FIGS. 6-9, user interfaces for selecting and processing task offers are shown and described. From an open application, a user may select a radius, corresponding to a distance, from a drop-down menu 605. The mobile device 350 may send the radius and location of the mobile device to the vendor task client application 365 on the server 305. The mobile device 350 may receive and display task offers 610a, 610b, 610c, 610d for vendors with enterprises within the radius of the user. The display may include the names of vendors, the distances to the enterprises, and the amount of compensation the user would receive for completing the task offer. In this example, the task offers 610 may be for a coffee shop 610a, a fast food chain 610b, a clothing store 610c, and an office supply store 610d.

A user may select a task offer by pressing an area of the mobile device's 350 touch screen corresponding to the task offer. If the user selects the task offer for the coffee shop 610a, the mobile device 350 may display the tasks 615, 620, 625 for the task offer. For provide data for a task 615, 620, 625, the user may touch an area of the device's 350 touch screen corresponding to the task. The mobile device 350 may display a control 630, such as a submit button, for sending information about the tasks to the server 305. The control 630 may be inactive until the user completes all the tasks in the offer.

When the user selects the task 615 for purchasing an item and capturing an item of the receipt, the vendor task client application 365 on the mobile device 350 may access the device's 350 camera function. The user may capture an image of the receipt for a purchased item. The image may be stored on the mobile device 350. Upon image capture, the mobile device 350 may display the tasks 615, 620, 625 for the task offer. The mobile device 350 may display a symbol 710 indicating that task 615 has been completed.

The user may select the task 620. The mobile device 350 may display a request for the user to check the cleanliness of the bathroom. The request may include possible conditions of the bathroom and radio buttons next to each of the conditions 715a, 715b, 715c, 715d (collectively, 715). A user may select the radio button corresponding to the user's answer. The user may select the control 720 to save the answer on the device 350.

Upon recordation of the answer, the mobile device 350 may return to the display of the tasks 615, 620, 625. The mobile device 350 may display a symbol 805 indicating that task 620 has been completed. The user may select the task 625. The mobile device 350 may display questions for the user to answer. The questions may require yes/no answers and radio buttons next to each of the answers, 810, 815. A user may select the radio buttons corresponding to the user's answers. The user may select the control 820 to save the answer on the device 350.

Upon recordation of the answers, the mobile device 350 may return to the display of the tasks 615, 620, 625. The mobile device 350 may display a symbol 825 indicating that task 620 has been completed. Because all of the tasks have been completed, the control 630 for submitting the data for the tasks may become active. A user may select the control 630 to send the data to the server 305. The mobile device 350 may submit the data to the server 305.

The server 305 may send a user interface 905 to the mobile device 350 acknowledging receipt of the data. The mobile device 350 may display the user interface 905. The user interface 905 may include a control 910 which the user may select to indicate the user has received the message on the interface 905. The mobile device 350 may return to the display of task offers 610. The display may include a symbol 920 indicating that the task offer for the coffee shop 610a has been completed. The user may select any other task offer, and the mobile device 350 will obtain the tasks from the server 305.

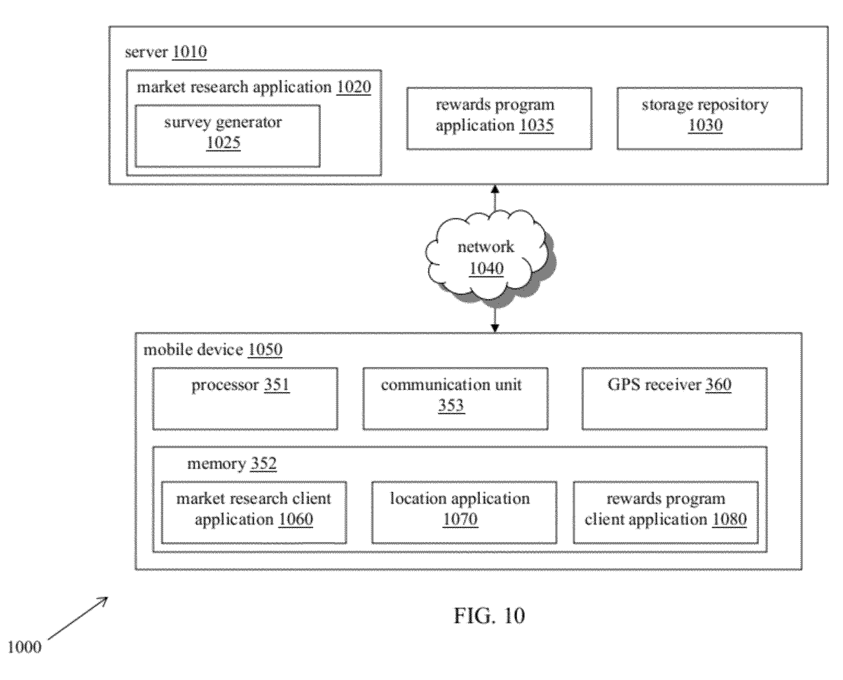

Referring now to FIG. 10, an exemplary system 1000 for deploying a location based market research program and/or a location based rewards program is shown and described. In some implementations, components of the system 1000 may be used with components of the system 300. Components of the system 1000 may operate according to similar components of system 300 (e.g., the systems' location applications 365, 1070 may operate in substantially the same manner). In some implementations, components of the systems 300, 700 may be combined into a single system (e.g., server 1010 may include the vendor task offer application 316).

The system 1000 may include a server 1010 that communicates with a mobile device 1050 over a network 1040. The server 1010, in some implementations, can comprise a storage repository 1030 and can execute a market research application 1020, a survey generator 1025, and a rewards program application 1035. The mobile device 350, in some implementations, can execute a market research client application 1060, a location application 1070, and a rewards program client application 1080.

Further referring to FIG. 10, and in more detail, in some implementations the server 1010 can be any computer including any computing machine 100 or 200 described herein. The server 1010 can be any type of server. For example, the server 1010 can be an application server, a file server, a proxy server, an appliance, a gateway server or any other server-type able to carry out the methods and systems described herein. In some implementations, the server 1010 can be a logical grouping of one or more servers which can be referred to as a server farm. Any one of the servers included within the logical grouping of servers can include a storage repository 1030 and can execute a market research application 1020, a survey generator 1025, and a rewards program application 1035. Instructions for the applications 1020, 1025, 1035 may be stored in a memory, and a processor (not shown) can execute the instructions. In some implementations, the server 1010 can be referred to as a remote computer or remote computing environment.

The mobile device 1050 can be any computer or mobile device including any computing machine 100, 200 described herein or the mobile device 350 described in reference to FIG. 3. For example, the mobile device 1050 may include the GPS receiver 360 of FIG. 3. The mobile device 1050 may include a communication unit 353. In some implementations, the communication unit 353 may communicate with cellular networks and/or computer networks. In some implementations, the mobile device 1050 can be a mobile device such as a tablet computer, a smart phone, a mobile phone, a personal digital assistant, or any other mobile device that has a processor and is able to carry out the methods and systems described herein.

In some implementations, the mobile device 1050 and the server 1010 can communicate over a network 1040. The network 1040 can be any network 1040 and in some implementations can be a local area network (LAN), a wide area network (WAN), a primary network, a sub-network, a public network, or a private network. In some implementations, the network can be a wireless network. In some implementations, the network can be a cellular network. The network can be a computer network. In some implementations, the network can have any network topology.

In some implementations, the server 1010 can execute a market research application 1020 that issues market research surveys to a user's mobile device 1050, gathers market research data from a user's mobile device 1050 and tracks market research data for one or more users. In some implementations, the market research application 1020 can be an application published by UNITED SAMPLE, INC. In some implementations, the market research application 1020 may be obtained from a centralized location for marketing mobile device 350 applications.

The market research application 1020 can communicate with a market research client application 1060 executing on a user's mobile device 1050 to obtain market research data about the user that uses the mobile device 1050. For example, the market research application 1020 can transmit user interfaces to the market research client application 1060 which can then display the received user interfaces on a display of the mobile device 1050. In some implementations, the market research application 1020 can transmit application data to the market research client application 1060 which can use the application data to generate surveys and user interfaces. Furthermore, the market research application 1020 can store and manage: user data; market research information obtained from a mobile device 1050; survey data; mobile device 1050 location information; survey information; vendor information; vendor statistics; vendor market research data; or any other information required to carry out the methods and systems described herein.

The market research application 1020 can communicate with mobile devices 1050 as well as vendors. In some implementations, a vendor can obtain user information and other market research that is relevant to a product or service provided by the vendor. Thus, in some instances the market research application 1020 interfaces with mobile devices 1050 accessed by users and with one or more computers maintained by a vendor.

The vendor, in some implementations, can be a third party that requests market research information from the market research application 1020. In one implementation, the vendor can interact with the market research application 1020 to configure an aspect of the market research application 1020. Configuring an aspect of the market research application 1020 can include indicating when and how many surveys a vendor would like transmitted to a user. In some implementations, the vendor can configure when, during the timeline of a transaction, to transmit a survey to the user. These configurations can be coded into the market research application 1020 through a configuration user interface or using a script.

In some implementations, the market research application 1020 can execute a survey generator 1025 that generates market research surveys. Surveys can be generated using vendor-specified information and guidelines. This information and guidelines can be any of the following: information about the vendor's products/services; guidelines that indicate what type of market research the vendor would like to perform; guidelines about types of questions to ask users or consumers; information about the vendor; information about a typical consumer; or any other relevant information or guideline that can be used to generate a survey. In some implementations, the surveys can be pre-generated or can be generated according to a survey template comprising vendor information and guidelines. When the survey is pre-generated, the survey generator 1025 may obtain the pre-generated survey from a storage repository 1030 rather than generate a survey responsive to a user's actions or responsive to user data. While FIG. 10 illustrates a market research application 1020 that includes a survey generator 1025, in some implementations the market research application 1020 can carry out the functionality of the survey generator 1025.

The market research application 1020 and survey generator 1025, in some implementations, can communicate with the storage repository 1030 to obtain vendor information, vendor guidelines, survey information, user information, or other similar types of information. In some implementations, the market research application 1020 and survey generator 1025 can communicate with the storage repository 1030 to store market research data, survey results, user information and vendor guidelines and information.

The server 1010 can comprise a storage repository 1030 that can store information generated or obtained by the market research application 1020, the survey generator 1025 or the rewards program application 1035. In some implementations, the storage repository 1030 can comprise one or more databases, tables or other storage elements.

Each mobile device 1050, in some implementations, can execute a market research client application 1060 that can communicate with a market research application 1020 executing on a remote server 1010. When a user of the mobile device 1050 wishes to install the market research application, the user can establish a connection with the market research application 1020 and request executable installation instructions. The market research application 1020 can respond to this request by transmitting or streaming the market research client application 1060 to the mobile device 1050. In turn, the mobile device 1050 can receive the streamed application and can install the application on the mobile device 1050. The market research client application 1060 can be obtained from a website, application store, email or other electronic source available on the mobile device 1050. In some implementations, installing the market research client application 1060 can include setting up a user account where a user can specify any of the following information: user identifier; user password; user information; user preferences; or any other similar information. When a user has a pre-existing account or multiple pre-existing accounts, the user can select which account the user would like to associate with that particular market research client application 1060. For example, the user can be registered to access a rewards program issued and managed by the third party that provides the market research application(s) 1020, 1060. In this example, the user already has an account with the third party and can therefore choose to associate that account with the market research client application 1060 or create a new account.

A market research client application 1060, in some implementations, locally executes on the mobile device 1050 to generate market research surveys, obtain a user's response to market research surveys, obtain the location of a user, provide the user with information regarding opportunities to provide feedback about a vendor, and establish a communication link with the market research application 1020. Furthermore, the market research client application 1060 can provide a user interface or portal through which a user can manage his/her settings and account. Management can include managing user information (e.g. home address, age, interests, gender, education level, etc.), managing a user identifier and/or user password, or managing a user's configuration settings. Configuration settings can include: a value indicating how many times a user wishes to receive market research surveys; an excluded list through which the user can prevent particular market research surveys from being sent to the user; a favorites list within which the user can specify a list of favorite vendors; or other similar configuration information.

In some implementations, the market research client application 1060 can include a user interface component through which a user can interact with both the client application 1060 and the market research application 1020. This user interface component can be accessed once a user logs into the market research application 1020, and can be populated with surveys and vendor information. In some implementations, the surveys, vendor information and in some instances the user interface information can be transmitted or streamed to the market research client application 1060 from the market research application 1020. Thus, the market research application 1020 can obtain user location information or user input and can responsively transmit or stream surveys, vendor information or user interface information to the mobile device 1050.

The server 1010 can further execute a rewards program application 1035. In some implementations, the rewards program application 1035 can execute in conjunction with the market research application 1020 to issue rewards to users that participate in surveys issued by the market research application 1020. Some implementations include a rewards program application 1035 that enrolls users in rewards programs designed to foster consumer loyalty and reward consumers for purchasing a particular vendor's products or services. The rewards program application 1035 can track user participation by tracking a user's purchases and tracking whether a user chooses a particular vendor when the user is in a geographic area.

In some implementations, the mobile device 1050 can execute a rewards program client application 1080 that can communicate with the rewards program application 1035 executing on the server 1010. The rewards program client application 1080 can execute a local version of the rewards application 1035 and can obtain rewards program information and display the information to a user of the mobile device 1050. In some implementations, the rewards programs and vendor information displayed by the rewards program client application 1080 can be obtained from the rewards program application 1035. Similarly, the rewards program application 1035 can transmit or stream to the mobile device 1050 a rewards program client application 1080 which can be used to locally execute rewards programs stored and managed by the rewards program application 1035.

The mobile device 1050 can further execute a location application 1070 that can be used to determine the location of the mobile device 1050. In some implementations, determining the location of the mobile device 1050 can include determining the coordinates of the mobile device 1050 on a global map. The mobile device 1050, in some implementations, can obtain its location using a global positioning system (GPS). In some implementations, the location application 1070 can be a GPS application, while in some implementations the location application 1070 can interface with a GPS application to obtain the geographic location of the mobile device. A GPS application, in some implementations, can obtain the geographic location of the mobile device 1050 from a satellite. This can be accomplished by transmitting a signal to a satellite, receiving a return signal from the satellite, and using trilateration to determine the coordinates of the source of the signal, e.g. the mobile device 1050. A mobile device's location can be described in terms of the mobile device's coordinate location on a global map, e.g. the latitude and the longitude of the location of the mobile device 1050 on the globe. While the location application 1070 can execute on the mobile device 1050 at the request of an application executing on the mobile device 1050, in some implementations the server 210 can instruct the location application 1070 to obtain the location coordinates of the mobile device.

In some implementations, the mobile device's location can be obtained from a third party application able to obtain mobile device location information. In one implementation, the mobile device location and the surrounding businesses and services can be obtained from a third party application such as FOURSQUARE, FACEBOOK, GOOGLE MAPS, BOOYA or any other application able to obtain position information for a mobile device and use that information to obtain business and service information.

The mobile device 1050 may include a market research client application 1060. In some implementations, mobile device 1050 may include an application in which participation in market research may be a function and/or subapplication. In some implementations, a user may obtain the market research client application 1060 from a website or centralized location, as described herein. Purchasing and/or requesting the market research client application 1060 may initiate a download from the centralized location to the mobile device 1050.

In operation, a user of the mobile device 1050 may request a display of at least one program to complete market research (also referred to herein as “research program”). In some implementations, the user may make the request by opening the market research client application 1060 on the device 1050 or accessing a function of an open application, according to any of the methods described herein. The application 1060 may require the user to enter credentials (e.g., username, password).

In response to the user's request, the location application 1070 on the mobile device 1050 may determine the device's location, according to any of the methods described herein. In some implementations, the location may include coordinates. The coordinates may correspond to the device's 1050 position on the surface of the earth. The coordinates may include Cartesian coordinates. The location may include coordinates for latitude and longitude. In some implementations, the location may include an address corresponding to the coordinates for the location.

The location application 1070 may send the location to the server 1010. In some implementations, the mobile device 1050 may send the username of the user of the device 1050. In some implementations, the mobile device 1050 may send an identifier of the device 1050 (e.g., device serial number). The mobile device 1050 may send any of the information described herein to the market research application 1020 on the server 1010.

The server 1010 may identify a user based on the username and/or identifier of the device 1050. The server 1010 may associate the location and the user. In some implementations, the server 1010 may retrieve a user profile associated with the user from the storage repository 1030. The user profile may include any information about the user. For example, the user profile may include the user's gender, age, income level, city of residence, or any other demographic information. In some implementations, the user profile may include a radius (e.g., a maximum distance between the user and vendors' enterprises for which research programs should be displayed to the user).

In some implementations, the market research application 1020 may identify at least one vendor research program based on the location of the mobile device 1050 and/or the user profile. The application 1020 may identify vendors with at least one enterprise (e.g., retail store, franchise) within a threshold distance of the device 1050. In some implementations, the application 1020 may query the storage repository 1030 for research programs associated with vendors with an enterprise within the threshold distance, according to any of the methods described herein. The threshold distance may be determined according to any of the methods described herein.

In some implementations, the market research application 1020 may identify a subset of the research programs to present to the user. For example, the application 1020 may apply one or more filters to the research programs associated with vendors with enterprises within a threshold distance of the user. Exemplary filters include categories of vendors (e.g., fast food restaurants, retail clothing stores, airports, coffee shops). For example, the market research application 1020 may identify research programs associated solely with fast food restaurants.

In some implementations, the application 1020 may identify research programs based on information in the user profile. The information may include data on the user's demographic group. The market research application 1020 may identify research programs based on vendors' needs for data from various demographic groups. For example, a vendor may indicate a need for market research for men with annual income levels between $50,000 and $100,000, but not on men with annual income levels between $100,000 and $200,000. In another example, a vendor may indicate a need for market research for women between the ages of 21 and 35 who live in suburban areas, but not for women in the same age bracket who live in urban areas. The market research application 1020 may identify research programs for which the vendors' targeted demographic group for the programs matches the user's demographic information.

In some implementations, more than one research program may be associated with a vendor. The application 1020 may identify one of the research programs based on the user profile. For example, a vendor may have research programs with different questions for users with different demographic information. The application 1020 may identify the vendor's research program that corresponds to the user's demographic information.

The profile may include behavioral information about the user. For example, the profile may include a list of vendors for which the user is already a repeat customer. The application 1020 may rank the research programs according to the list. In some examples, the profile may include the research programs the user has previously completed. The research programs the application 1020 has identified based on location may include conditions regarding the user's past behavior. For example, a research program may indicate that a user may not participate in the research if the user has already conducted the same research a predetermined number of times within a period of time (e.g., the user has already performed the research three times in the past week).

In some implementations, the application 1020 may obtain research programs for identified vendors with at least one enterprise within one or more threshold distances of the user. For example, the application 1020 may retrieve the research programs from the storage repository 1030. In some implementations, the research program may include an amount of compensation for a user who completes the research program. The compensation may be any form of compensation described herein.

The research program may include a single amount of compensation. The research program may include different amounts of compensation and conditions associated with each amount. Conditions may include requirements regarding demographic information (e.g., vendors may program different amounts of compensation to encourage participation from members of demographics for which the vendors may have less information), as described herein.

The application 1020 may send descriptions of the research programs to the mobile device 1050. Each description may include the name of the vendor, the address of the vendor's enterprise, and/or an amount of compensation for completing the research requested by the vendor. The mobile device 1050 may display a list of the research programs.

The user may select a research program according to any of the methods for select offers or programs described herein. The market research client application 1060 may send the selection to the market research application 1020 on the server 1010. In some implementations, upon the user selection of the research program, the location application 1070 may obtain the device's 1050 location. The location application 1070 may send the updated location to the server 1010. The market research application 1020 on the server 1010 may determine the user remains within a threshold distance of the enterprise before sending the inquiries of the research program to the mobile device 1050.

In some implementations, the market research application 1020 on the server 1010 may obtain the first inquiry of the selected research program and process the inquiry for display, according to any of the methods described herein. Inquiries may include questions regarding the user's experience at the enterprise. For example, an inquiry may ask what motivated a user to go to the enterprise. An inquiry may ask about the extent of crowdedness in the enterprise. An inquiry may ask about the number of cashiers available to service customers in a retail store. An inquiry may ask if the user made a purchase, and why or why not. An inquiry may ask the user for demographic information about himself or herself (e.g., age, gender, residence, income bracket). An inquiry may ask the user about his or her consumption patterns (e.g., use of product and/or service, frequency of use). An inquiry may ask the user regarding customer traffic at the enterprise and at a competing vendor's nearby enterprise.

The user may input a response to the first inquiry into the mobile device 1050. In some implementations, the market research client application 1060 may measure a period of time that elapses between display of the inquiry and the user's entry of the response. In some implementations, the client application 1060 may append a time, date, and/or location of entry to the response. The client application 1060 may send the response to the server 1010.

The market research client application 1060 may determine the acceptability of the response according to any of the methods described herein. In some implementations, the market research client application 1060 may notify the mobile device 1050 that the response is unacceptable. The application 1020 may send the device 1050 a notification for display. The application 1020 may request or not request a resubmission of a response. In some implementations, if a response is unacceptable because the user is providing nominal responses, the application 1020 may determine the user is an uncredible source of information and terminate the research program.

The market research application 1020 may obtain the next inquiry of the research program. The mobile device 1050 may display the inquiry and the user may respond according to any of the steps described herein. The applications 1020, 1060 may perform any of the steps described herein for each inquiry in the research program.

After the market research application 1020 has received responses for all the inquiries of the market research program, the application 1020 may determine whether the amount of compensation should be allocated to the user. The application 1020 may determine the compensation should be allocated when all the user responses are acceptable. The application 1020 may determine the compensation should be allocated when a threshold number and/or percentage of responses are acceptable user submitted data is acceptable, according to any of the steps described herein. In some implementations, the application 1020 may determine compensation should not be allocated when a user's response to an inquiry indicates the user is not a member of the vendor's target demographic group. In some implementations, the application 1020 may determine compensation should not be allocated when a user's response to an inquiry indicates the user does not fulfill at least one condition for the market research program (e.g., ownership and/or regular use of a product, residency in an identified area, completion of the research program within a threshold period of time and/or threshold distance from the enterprise).

The application 1020 may increase an account associated with the user by the amount of compensation. The application 1020 may notify the user according to any of the steps described herein.

In some implementations, while the market research client application 1060 is active, the location application 1070 may determine the device's 1050 location on a periodic basis (e.g., once every 3 minutes, 10 minutes). The location application 1070 may send the updated location to the market research application 1020 on the server 1005. The application 1020 may determine research programs available within the threshold distance(s) of the updated location. The application 1020 may send descriptions of the updated task programs to the mobile device 1050 for display.

In some implementations, the market research application 1020 may identify a research program associated with a vendor with an enterprise that is not within a threshold distance of the device 1050. The market research client application 1060 may notify the user that the research programs may become available once the user moves within the threshold distance to the enterprise.

In some implementations, the market research application 1020 may send all the user interfaces for all the requests for data in a research program to the mobile device 1050, as described herein. In some implementations, the mobile device 1050 may store data from the user if the device 1050 cannot communicate with the market research application 1020 and send the data when communication resumes, as described herein. In some implementations, the market research client application 1060 may be embedded in an application for a third-party.

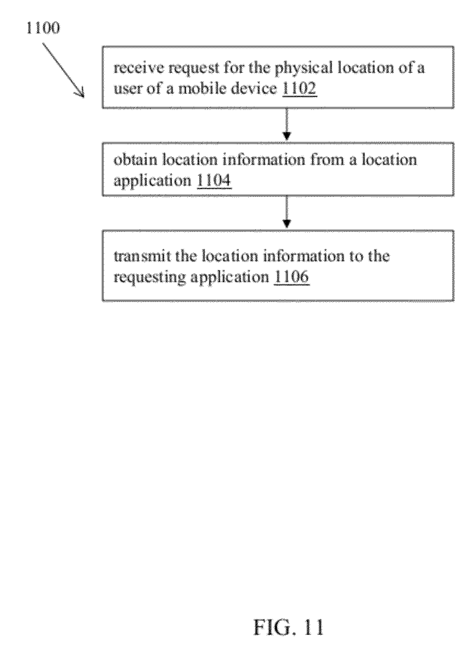

Referring now to FIG. 11, a flow diagram of an exemplary method 1100 for determining the location of a user of a mobile device is shown and described. Although the steps are described herein with reference to mobile device 1050, the mobile device 350 described in reference to FIG. 3 may perform the steps, as may any other mobile device.

A mobile device 1050 can receive a request for the physical location of the mobile device 1050 (Step 1102). Upon receiving the location request, the mobile device 1050 can query a location application 1070 for the device's physical location and can obtain from the location application 1070 location information indicating the physical location of the mobile device 1050 (Step 1104). The mobile device 1050 can then transmit the obtained location information to the application or device that requested the information (Step 1106).

In more detail, in some implementations the mobile device 1050 can receive a request for the physical location of a user of a mobile device 1050 (Step 1102). In some implementations, this request can be issued by a market research application executing on a remote computer or server 1010. In some implementations, this request can be issued by a market research application 1020 in response to a user's request for market research surveys. In still some implementations, this request can be issued by a rewards program application 1035 in response to a user's request for consumer reward programs. The request for the physical location of the user of the mobile device 1050 can be a request for the physical location of the mobile device. This physical location can include the latitude and longitude of the mobile device. In some implementations, the physical location can be described in terms of the mobile device's proximity to a landmark or object. For example, the mobile device's location can be described in terms of the mobile device's proximity to a radio tower or satellite. The request can be issued in response to user input, e.g. a user executing an application or selecting a program. In some implementations, the request can be transmitted on a periodic basis.

Upon receiving the request, the mobile device 1050 can obtain location information from a location application 1070 (Step 1104). In some implementations, the location application 1070 executes on the mobile device 1050 and can therefore transmit location information to other applications executing on the mobile device 1050 through application program interfaces or other means of transmitting data amongst applications. In one implementation, the location application 1070 executes on a remote computer. In this implementation, the mobile device 1050 obtains the location information by issuing a request for the location information to the remote computer. The remote computer, in response to the request issued by the mobile device 1050, transmits the mobile device's location information to the mobile device 1050. The remote computer, in some implementations, is the server 1010.

The mobile device 1050 can transmit the location information to the requesting application (Step 1106). In some implementations, the mobile device 1050 transmits the location information to the market research application 1020 executing on the server 1010. In some implementations, the mobile device 1050 transmits the location information to the rewards program application 1035 executing on the server 1010.

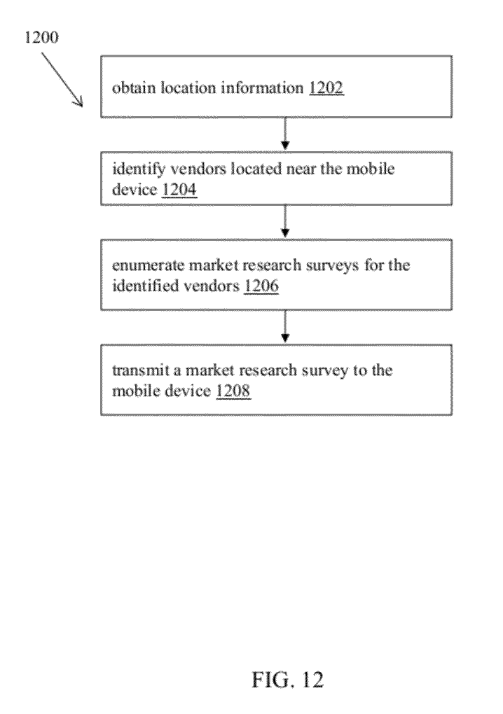

Referring now to FIG. 12, a flow diagram for an exemplary method 1202 for identifying and transmitting market research surveys to a mobile device is shown and described. In some implementations, a market research application 1020 obtains location information from a mobile device 1050 (Step 1202). The market research application 1020 then identifies one or more vendors that are located near the mobile device 1050 (Step 1204), and enumerates market research surveys for those identified vendors (Step 1206). At least one of the enumerated market research surveys are then transmitted to the mobile device 1050 (Step 1208).

In more detail, the market research application 1020 may obtain location information from a mobile device 1050 (Step 1202). The location information obtained, in some implementations, can be the physical location of the mobile device 1050. Obtaining the information can include querying the mobile device 1050 for the coordinates of the mobile device 1050. When a mobile device 1050 receives a query for its coordinates, in some implementations the mobile device 1050 can respond by retrieving its location from memory or executing a location application 1070 that can retrieve the coordinate location of the mobile device 1050. Querying the mobile device 1050 for location information can include a server or other computer issuing a request for the physical location of the mobile device 1050, and then receiving the physical location information for the mobile device 1050. The location information can be obtained by a location application executing on the mobile device 1050. Once the location application 1070 obtains the physical location of the mobile device 1050, the location application 1070 can transmit the physical location of the mobile device 1050 to the market research application 1020. In some implementations, the market research application 1020 obtains the mobile device's location information from a storage repository on the server. In these implementations, the mobile device 1050 can periodically transmit its location to the server where the location information is stored in a memory location or storage repository.

Location information can be information describing the physical location of the mobile device 1050. The physical location can be described in terms of longitudinal and latitudinal coordinates. In some implementations, the physical location can be described in terms of the mobile device's proximity to a landmark such as a cell phone tower, base or vendor.

Upon obtaining the location of the mobile device 1050, the market research application 1020 can identify one or more vendors that are located near the mobile device 1050 (Step 1204). In some implementations, identifying the vendors can include querying a database for vendors that are located proximate to the mobile device 1050. Proximity can be determined based on a predefined distance range. For example, a proximity value could be a value that defines a proximate vendor as a vendor within a predetermined distance from the mobile device 1050. In one implementation, an application executing on the server can determine the distance between a vendor and the location of the mobile device 1050. Using this determined distance value, the market research application 1020 can determine whether the vendor is within a predefined distance range. For example, if the predefined distance range is five miles, the market research application 1020 may calculate the distance between all vendors and the mobile device 1050, and select those vendors that are within five miles of the mobile device 1050. The predefined distance range or proximity value can be a hard coded value or can be a value transmitted by a user.

In some implementations, identifying vendors can include searching through a database for vendors that have a location that is proximate to the location of the mobile device 1050. In some implementations, identifying vendors can include identifying all vendors in the same town as the town where the mobile device 1050 is located. In still some implementations, identifying vendors can include identifying all vendors having the same zip code as the zip code where the mobile device 1050 is located.

The market research application 1020, in some implementations, identifies proximate vendors by first approximating an address for the mobile device 1050. Approximating an address can include assigning an address to the mobile device 1050 based on the physical location of the mobile device 1050. This address can be the address of the landmark physically located closest to the mobile device 1050. In some implementations, the address can be determined based on the address information for those landmarks physically located closest to the mobile device 1050. In some implementations, the mobile device's approximate address is determined before the distance between the mobile device 1050 and potential vendors is determined.

Once the market research application 1020 identifies those vendors that are located near or proximate to the mobile device 1050, the market research application 1020 can enumerate market research surveys for the identified vendors (Step 1206). Enumerating the market research surveys can include obtaining the surveys from a database or other storage repository. The surveys, in some implementations, can be stored with a vendor identifier such that the surveys can be found by searching for an identified vendor. The identified vendors can have vendor identifiers, thus searching for market research surveys can include searching for the vendor identifiers of the identified vendors. Enumerating the surveys, in one implementation, includes querying a database for market research surveys that are associated with the identified vendors. In some implementations, enumerating market research surveys can include obtaining the relevant market research surveys and temporarily storing them in a buffer or other short-term memory location.

In some implementations, the market research application 1020 can transmit all the market research surveys to the mobile device 1050 (Step 1208). In some implementations, the market research application 1020 can transmit a subset of the enumerated market research surveys to the mobile device 1050. The market research application 1020 or another application executing on the server can transmit the surveys to a mobile device 1050. In some implementations, the surveys are transmitted to a market research client application 1060 executing on the mobile device 1050. In some implementations, the surveys are streamed to the mobile device 1050.

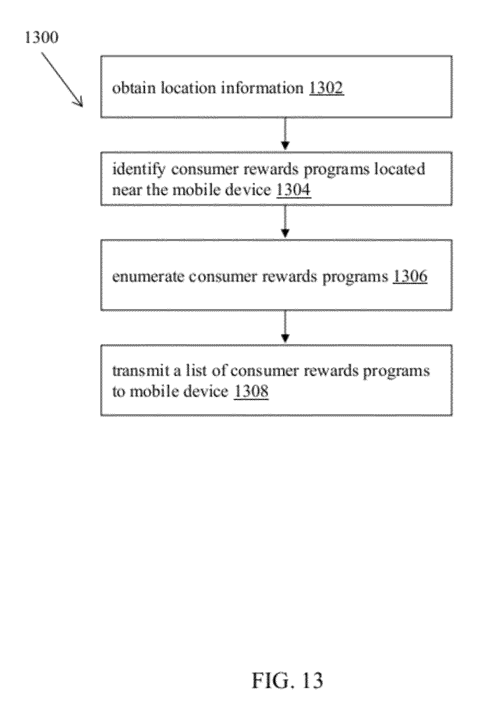

Referring now to FIG. 13, a flow diagram of an exemplary method 1300 for identifying consumer rewards programs located near a mobile device 1050 is shown and described. A rewards program application 1035 executing on a server can obtain the physical location of a mobile device 1050 (Step 1302) and identify those consumer rewards programs that are located near the mobile device 1050 (Step 1304). The rewards program application 1035 can then enumerate all the relevant consumer rewards programs (Step 1306) and transmit a list of relevant consumer rewards programs to the mobile device 1050 (Step 1308).

In more detail, in one implementation the rewards program application 1035 can obtain the physical location of the mobile device 1050 by obtaining the location information for the mobile device 1050 (Step 1302). The location information obtained, in some implementations, can be the physical location of the mobile device 1050. Obtaining the information can include querying the mobile device 1050 for the coordinates of the mobile device 1050. When a mobile device 1050 receives a query for its coordinates, in some implementations the mobile device 1050 can respond by retrieving its location from memory or executing a location application 1070 that can retrieve the coordinate location of the mobile device 1050.

Querying the mobile device 1050 for location information can include a server or other computer issuing a request for the physical location of the mobile device 1050, and then receiving the physical location information for the mobile device 1050. The location information can be obtained by a location application 1070 executing on the mobile device 1050. Once the location application 1070 obtains the physical location of the mobile device 1050, the location application 1070 can transmit the physical location of the mobile device 1050 to the rewards program application 1035. In some implementations, the rewards program application 1035 obtains the mobile device's location information from a storage repository on the server. In these implementations, the mobile device 1050 can periodically transmit its location to the server where the location information is stored in a memory location or storage repository.

Location information can be information describing the physical location of the mobile device 1050. The physical location can be described in terms of longitudinal and latitudinal coordinates. In some implementations, the physical location can be described in terms of the mobile device's proximity to a landmark such as a cell phone tower, base or vendor.

Upon obtaining the mobile device's physical location, the rewards program application 1035 can use this information to identify consumer rewards programs that are located near the mobile device 1050 (Step 1304). Identifying these rewards programs can first require the rewards program 1035 to identify vendors that are located near the mobile device 1050. The rewards program application 1035 can identify the vendors by querying a database for vendors that are located proximate to the mobile device 1050. Proximity can be determined based on a predefined distance range. For example, a proximity value could be a value that defines a proximate vendor as a vendor within a predetermined distance from the mobile device 1050. In one implementation, an application executing on the server can determine the distance between a vendor and the location of the mobile device 1050. Using this determined distance value, the rewards program application 1035 can determine whether the vendor is within a predefined distance range. For example, if the predefined distance range is five miles, the rewards program application 1035 may calculate the distance between all vendors and the mobile device 1050, and select those vendors that are within three miles of the mobile device 1050. The predefined distance range or proximity value can be a hard coded value or can be a value transmitted by a user.

In some implementations, identifying vendors can include searching through a database for vendors that have a location that is proximate to the location of the mobile device 1050. In some implementations, identifying vendors can include identifying all vendors in the same town as the town where the mobile device 1050 is located. In still some implementations, identifying vendors can include identifying all vendors having the same zip code as the zip code where the mobile device 1050 is located. The rewards program application 1035, in some implementations, identifies proximate vendors by first approximating an address for the mobile device 1050. Approximating an address can include assigning an address to the mobile device 1050 based on the physical location of the mobile device 1050. This address can be the address of the landmark physically located closest to the mobile device 1050. In some implementations, the address can be determined based on the address information for those landmarks physically located closest to the mobile device 1050. In some implementations, the mobile device's approximate address is determined before the distance between the mobile device 1050 and potential vendors is determined

Upon identifying vendors that are physically located near the mobile device 1050, the rewards program application 1035 can then identify those vendors that have rewards programs. Upon identifying those vendors that have rewards programs, the rewards program application 1035 can enumerate the consumer rewards programs (Step 1306) that are located near the mobile device 1050. Enumerating the proximate rewards programs can include determining which proximate vendors have rewards programs. In some implementations, this determination can further include determining whether a user of the mobile device 1050 qualifies for the identified rewards programs and enumerating those rewards programs that the user of the mobile device 1050 qualifies for.

The rewards program application 1035 can transmit a list of the enumerated rewards programs to the mobile device 1050. This list can include all enumerated consumer rewards programs or can include a subset of the enumerated rewards programs.

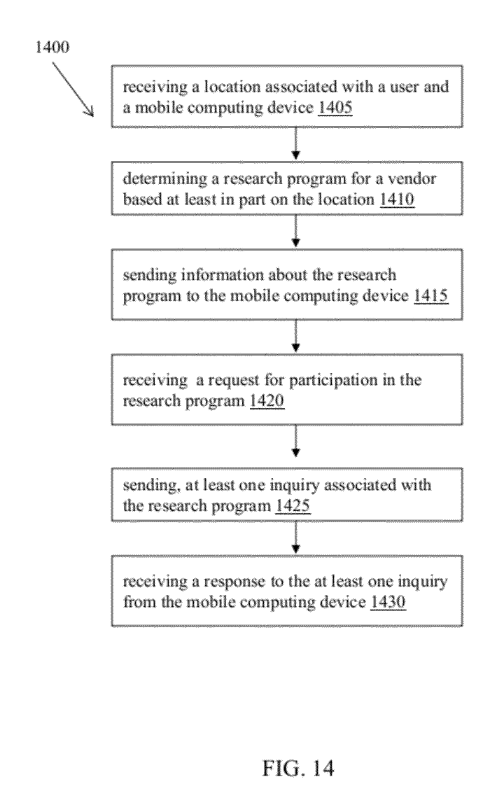

Referring now to FIG. 14, a flow diagram of an exemplary method 1400 for selecting and processing a research program is shown and described. The method may include receiving a location associated with a user and a mobile device (step 1405). A server 1010 may receive a location from a market research client application 1060 executing on a mobile device 1050. The location may include coordinates associated with the mobile device.

The method may include determining a research program for a vendor based at least in part on the location (step 1410). The market research application 1020 executing on the server 1010 may retrieve a location of an enterprise associated with a vendor. The application 1020 may retrieve the location from a storage repository. The application 1020 may determine a distance between the enterprise and the mobile device 1050. The application 1020 may compare the distance with a threshold (e.g., any of the threshold distances described herein). When the threshold exceeds the distance, the application 1020 may select the research program for the vendor.

In some implementations, the application 1020 may select a plurality of research programs for vendors with enterprises located within a threshold distance of the mobile device. The application 1020 may sort the plurality of research programs based at least in part on distances between the location of the mobile device 1050 and locations of the enterprises. The application 1020 may select a subset of the plurality of research programs based at least in part on the distances. For example, the application 1020 may select the research programs for the five closest enterprises to the mobile device 1050.

In some implementations, the application 1020 may select a research program based at least in part on information (e.g., demographic information, user participation in research programs) about the user. For example, a vendor may desire market research on an identified demographic group. If the vendor's desired demographic group matches the user's demographic information, the application 1020 may select the vendor's research program. In some examples, a vendor may refuse market research from users who have participated in its programs a predetermined number of times within a predetermined period of time. Thus, a user who has participated in two research programs for a vendor within the past twenty-four (24) hours may be ineligible for further participation in the vendors' programs. The application 1020 may not select research programs associated with the vendor.

In some implementations, the application 1020 may determine an amount of compensation for the user for participating in the research program. A vendor may determine different amounts of compensation for members of different demographic groups, according to the vendor's need for market research on the group. The application 1020 may determine an amount of compensation for the demographic group corresponding to the user.

The method may include sending information about the research program to the mobile device (step 1415). The application 1020 may send the information to the market research client application 1060 on the mobile device 1050. The information may include the identity of the vendor, a description of the research program, a location of an enterprise associated with the vendor, the distance between the enterprise and the mobile device 1050, the amount of compensation, and/or any other information described herein.

The method may include receiving a request for participation in the research program (step 1420). The request for participation may include a selection of a research program by the user. The market research application 1020 may retrieve from the storage repository the inquiries of the program. The method may include sending at least one inquiry associated with the research program to the mobile device (step 1425). The application 1020 may send a first, second, or any other inquiry of the research program to the mobile device 1050, according to any of the steps described herein.

The method may include receiving a response to the at least one inquiry from the mobile device (step 1430). The application 1020 may receive a response to any inquiry sent to the mobile device 1050. The application 1020 may determine the acceptability of any response, according to any of the steps described herein. In some implementations, the method may include increase an account of the user by an amount of compensation. The application 1020 may increase the account if the responses to the inquiries are acceptable.

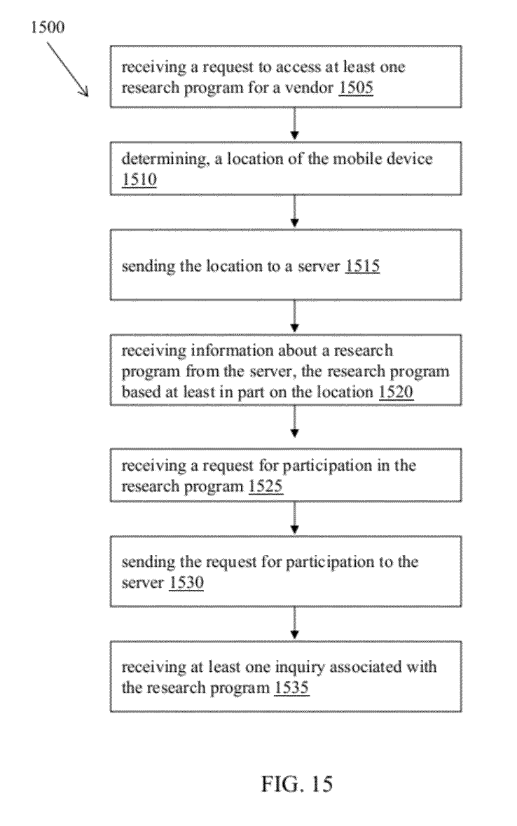

Referring now to FIG. 15, a flow diagram of an exemplary method 1500 for selecting and processing a research program is shown and described. The method may include receiving a request to access at least one research program for a vendor (step 1505). A mobile device 1050 may receive the request from a user. The user may make the request by opening a market research client application 1060 on a mobile device 1060, according to any of the steps described herein.

The method may include determining a location of the mobile device (step 1510). A location application 1070 executing on the mobile device 1050 may determine the location. The location application 1070 may determine the location according to signals from GPS satellites, cellular networks, computer networks, or any other system that includes location information. The location may include coordinates.

The method may include sending the location to a server (step 1515). The server 1010 may send the location to a market research application 1020 executing on the server 1010. The server may determine one or more research programs the user may participate in, based at least in part on the location, according to any of the steps described herein. The server 1010 may send information about the research programs to the mobile device 1050.

The method may include receiving information about a research program from the server, the research program based at least in part on the location (step 1520). Information about the research program may include the identity of the vendor associated with the program, a location of the vendor's enterprise, a distance from the user's location to the enterprise, a description of the research program, an amount of compensation for completing the research program, and/or any other information described herein. The mobile device 1050 may receive information about more than one research program.

The method may include receiving a request for participation in the research program (step 1525). The user may request participation in the research program by selecting the research program on the display, according to any of the steps described herein. The mobile device 1050 may receive the request. The method may include sending the request for participation to the server (step 1530). The mobile device 1050 may send the request for participation in the research program to the market researching application 1020 on the server 1010. In some implementations, the location application 1070 may update the device's 1050 location. The mobile device 1050 may send the location with the request for participation. The mobile device 1050 may send an identifier of the user (e.g., username).

The method may include receiving at least one inquiry associated with the research program (step 1535). In some implementations, the market research client application 1060 on the mobile device 1050 may receive a list of inquiries associated with the research program. The client application 1060 may receive an inquiry for display on the mobile device 1050. The inquiry may include a question and possible responses. The inquiry may include an open-ended question. The user may respond to the inquiry by selecting one of the possible responses (e.g., selecting a radio button corresponding to the response). The user may respond by entering text. The method may include sending a response to the at least one inquiry to a server.

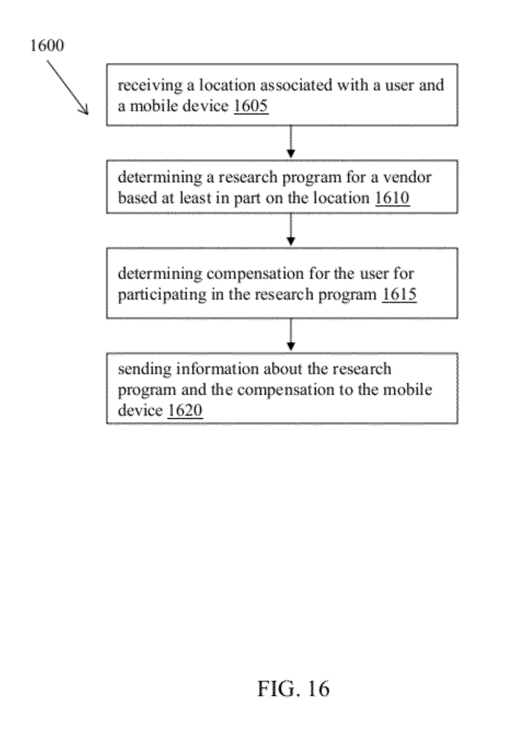

Referring now to FIG. 16, a flow diagram of an exemplary method 1600 for determining a research program and compensation for a user is shown and described. The method may include receiving a location associated with a user and a mobile device (step 1605). A research marketing application 1020 executing on a server 1010 may receive the location from a communication unit 353 of a mobile device 1050. The location may include the coordinates of the mobile device. The server 1010 may receive an identifier of the user (e.g., username). The server 1010 may receive an identifier of the mobile device 1050 (e.g., serial number). The server 1010 may determine the user from the user identifier and/or the mobile device 1050 identifier. The server 1010 may associate the location and the user.

The method may include determining a research program for a vendor based at least in part on the location (step 1610). In some implementations, a server 1010 may identify vendors with enterprises within a threshold distance of the user's location, according to any of the steps described herein. The server 1010 may select the research programs of the identified vendors.

In some implementations, the market research application 1020 may retrieve a location of an enterprise associated with the vendor. The application 1020 may compare a threshold (determined according to any of the steps described herein) with a distance between the location associated with the mobile device and the location of the enterprise. The application 1020 may select the research program for the vendor when the threshold exceeds the distance.

In some implementations, the market research application 1020 may select a plurality of research programs for vendors with enterprises located within a threshold distance of the location associated with the mobile device. The application 1020 may sort the plurality of research programs based at least in part on distances between the location of the mobile device and locations of the enterprises. For example, the application 1020 may rank and/or order the research programs according to the distances. The application 1020 may assign higher rankings to research programs associated with closer enterprises. The application 1020 may select a subset of the plurality of research programs based at least in part on the distances. For example, the application 1020 may select the research programs for the five closest enterprises to the user, although the application 1020 may select any number of research programs.

In some implementations, the market research application 1020 may determine the research program based at least in part on information about the user. Information about the user may include demographic information. For example, vendors may indicate needs for market data from targeted demographic groups, as described herein. In some implementations, only users from a demographic group identified by a vendor may be eligible for participation in a research program. When the user's demographic information matches the demographic group identified by the vendor, the market research application 1020 may select the research program.

Information about the user may include the user's participation in research programs. For example, vendors may limit the number of times users may participate in their research programs. A vendor may allow a user to participate in its research programs twice a week, although other conditions may be used. Thus, if a user has already participated in the vendor's research program twice in the past week, the market research application 1020 may not select the research program. If the user meets the vendor's conditions regarding past participation in research programs, the application 1020 may select the research program.

The method may include determining compensation for the user for participating in the research program (step 1615). The rewards program application 1035 may determine the compensation. In some implementations, the research program may indicate compensation for users who complete the research program. The compensation may include any of the types of compensation described herein. In some implementations, the research program may include the same amount of compensation for all users. In some implementations, users from different demographic groups may be eligible for different amounts of compensation, according to any of the steps described herein.

The method may include sending information about the research program and the compensation to the mobile device (step 1620). Information about the research program may include an identity of the vendor, an address of the enterprise associated with the vendor, a distance between the enterprise and the user/mobile device 1050, and/or any other information described herein. Information about the compensation may include the type of compensation and/or the amount of compensation for participating in and/or completing the research program.

The method may include receiving a response to at least one inquiry associated with the research program from the mobile device and determining acceptability of the response, according to any of the steps described herein. The method may include increasing an account of the user based at least in part on the compensation and the acceptability of the response, according to any of the steps described herein. The method may include re-sending at least one inquiry to the mobile device based on the acceptability of the response, according to any of the steps described herein.

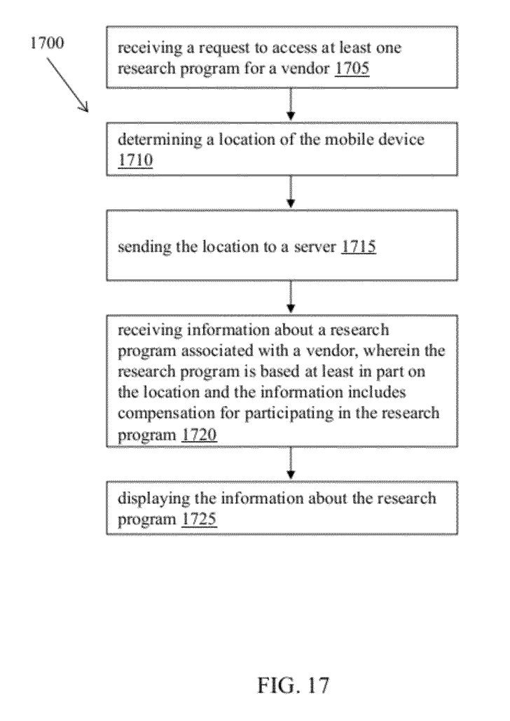

Referring now to FIG. 17, a flow diagram of an exemplary method 1700 for determine research programs and compensation for a user is shown and described. The method may include receiving a request to access at least one research program for a vendor (step 1705). A mobile device 1505 may receive the request according to any of the steps described herein. The method may include determining a location of the mobile device (step 1710). The mobile device 1505 may determine the location based on signals received from positioning satellites, cellular networks, computer networks, or any other type of network described herein. The mobile device 1505 may determine the location according to any of the methods described herein or any other method as would be appreciated by one of ordinary skill in the art. The location may include the coordinates of the mobile device 1505.

The method may include sending the location to a server (step 1715). A market research application 1020 and/or rewards program application 1035 executing on the server 1010 may receive the location. The market research application 1020 may determine a research program based at least in part on the location, according to any of the steps dscribed herein. The rewards program application 1035 may determine compensation for participating in the research program, according to any of the steps dscribed herein. The applications 1020, 1035 may send information about the research program and/or compensation to the mobile device 1050.

The method may include receiving information about a research program associated with a vendor from the server (step 1720). The research program may be based at least in part on the location, as described herein. Information about the research program may include compensation for participating in the research program, as described herein.

The method may include displaying the information about the research program (step 1725). The mobile device 1050 may display an identity of the vendor and a description of the research program. The mobile device 1050 may display an identity of the vendor, a description of the research program, and information about the compensation. The mobile device 1050 may display a distance between the location associated with the mobile device and a location of an enterprise associated with the vendor.

The method may include sending a response to an inquiry associated with the research program and receiving a message that the response has been rejected by the research program, according to any of the steps described herein.

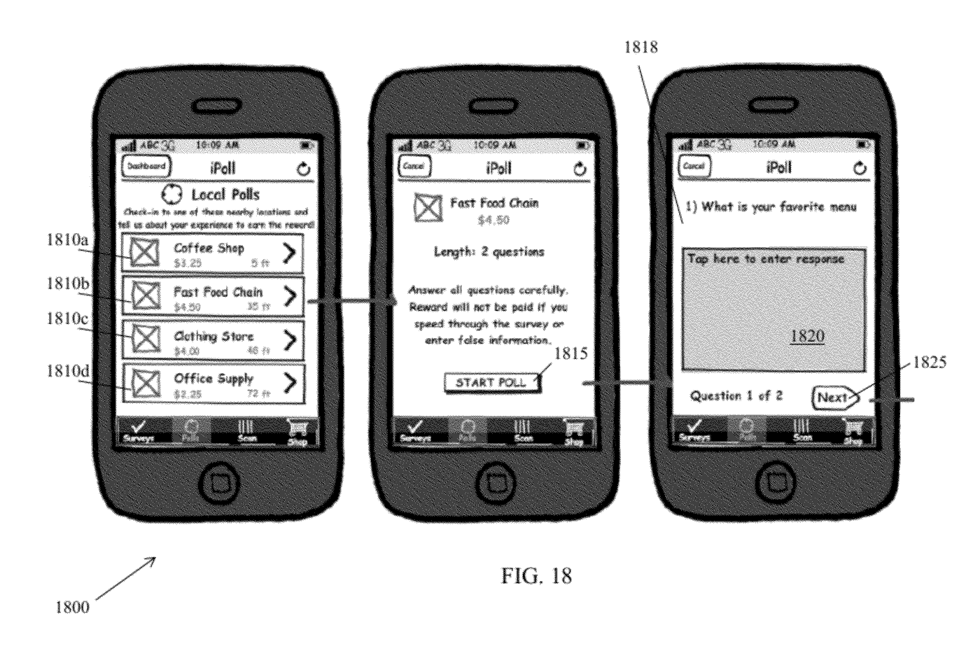

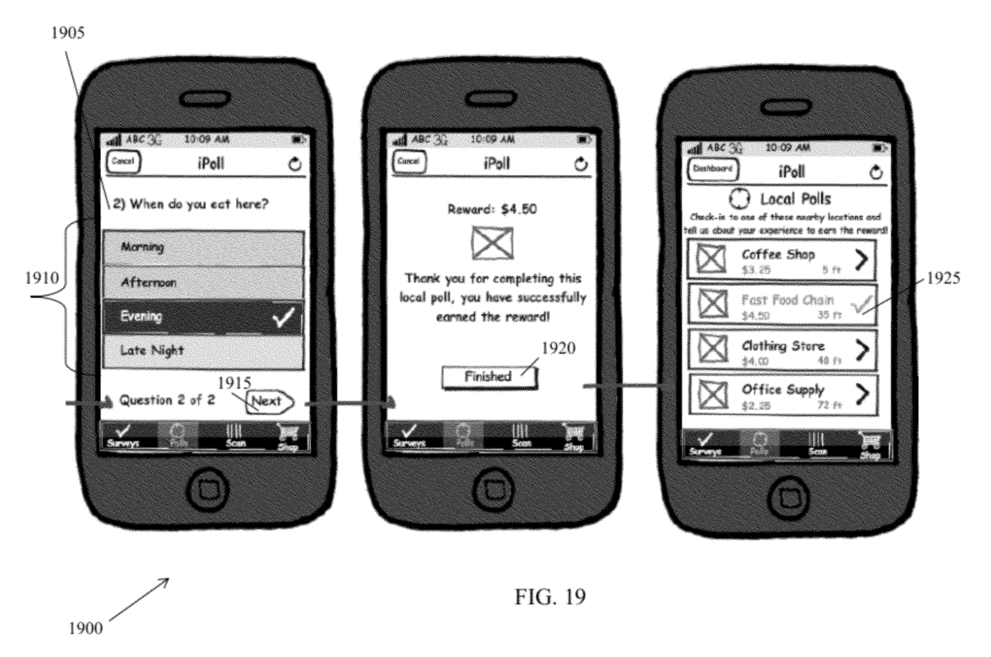

Referring now to FIGS. 18 and 19, exemplary user interfaces for selecting and processing research programs and compensation are shown and described. A market research client application 1060 executing on a mobile device 1050 may receive and display information about research programs for display. The information may include the identities of vendors associated with the research programs, the amounts of compensation for participating in the research programs, and the distances to the vendors' enterprises. In this implementations, the research programs 1810a, 1810b, 1810c, and 1810d may be associated with a coffee shop, fast food chain, clothing store, or office supply store, respectively. A user may request to participate in a research program by selecting an area on the device's 1050 touchscreen corresponding to the program.

In this implementation, the user may select the research program associated with the fast food chain. The mobile device 1050 may display a user interface describing the content of the research program (e.g., 2 questions). The user interface may include a notification that payment of the compensation may be contingent upon third-party satisfaction with the user's data. The user interface may include a control 1815 for starting the research program.

A user interface 1818 may display the first question of the market research program. The first question may be an open-ended question. The user interface 1818 may include a field 1820 in which the user may input his or her answer to the question. The user interface 1818 may include a control 1825, by which the user may access the next question in the research program. In some implementations, in response to selection of the control 1825, the mobile device 1050 may submit the user's response to the server 1010.

A user interface 1905 may display the second question of the market research program. The second question may include options 1910 for the response. The user may select one of the options. For example, the user may contact an area of the device's 350 touch screen corresponding to one of the options. The user interface 1905 may include a control 1915. In response to the user's selection of the control 1915, the mobile device 1050 may submit the user's selection of the option to the server 1010.

The market research application 1020 on the server 1010 may determine the acceptability of the user's responses, according to any of the steps described herein. The application 1020 may determine the responses are acceptable. The application 1020 may send a notification to the mobile device 1050 indicating the responses are acceptable. The notification may indicate that the user will receive the amount of compensation for completing the research program. The user may select a control 1920 to complete the research program. In response, the mobile device 1050 may display the research programs. The display may include a symbol 1925 indicating the research program for the fast food chain has been completed.

While various implementations of the methods and systems have been described, these implementations are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary implementations and should be defined in accordance with the accompany claims and their equivalents.

What is claimed is:

1. A method for issuing a market research survey to a consumer based on a physical location of the consumer, the method comprising:
obtaining, by a market research application executing on a computer, physical location information for a user of a mobile device remotely located from the computer;
identifying, by the market research application, vendors having a physical location proximate to the mobile device location information;
enumerating one or more market research surveys for the identified vendors; and
transmitting at least one of the enumerated market research surveys to the user of the mobile device.

2. The method of claim 1, further comprising:
issuing, by the market research application, a request for the physical location of the mobile device; and
receiving, from the mobile device, location information for the physical location of the mobile device.

3. The method of claim 2, further comprising:
receiving, by the mobile device, the request issued by the market research application;
querying a location application for location information representative of the physical location of the mobile device;
receiving location information from the location application; and
transmitting the location information to the market research application executing on the remote computer.

4. The method of claim 1, wherein identifying vendors further comprises:
using the location information of the mobile device to approximate an address for the mobile device; and
enumerating all vendors within a predetermined distance from the approximated address of the mobile device.

5. The method of claim 4, wherein enumerating vendors within a predetermined distance further comprises:
obtaining, from a vendor database, addresses of vendors having a predetermined zip code;
determining, for each obtained address, a distance from that address to the approximated address of the mobile device; and
selecting, based on the determined distances, a subset of the enumerated vendors.

6. The method of claim 1, wherein obtaining location information further comprises obtaining coordinates of the mobile device.

7. The method of claim 1, wherein enumerating one or more market research surveys further comprises querying a database for market research surveys associated with the identified vendors.

8. A system for issuing a market research survey to a consumer based on a physical location of the consumer, the system comprising:
a mobile device accessed by a user, the mobile device remotely located from a computer;
a market research application executing on the computer to:
obtain physical location information for the user of the mobile device,
identify vendors having a physical location proximate to the mobile device location information,
enumerate one or more market research surveys for the identified vendors;
the computer transmitting at least one of the enumerated market research surveys to the user of the mobile device.

9. The system of claim 8, wherein the market research application issues a request for the physical location of the mobile device; and receives location information for the physical location of the mobile device from the mobile device.

10. The system of claim 9, wherein the mobile device receives the request issued by the market research application and:
queries a location application for location information representative of the physical location of the mobile device,
receives location information from the location application, and
transmits the location information to the market research application executing on the remote computer.

11. The system of claim 8, wherein the market research application identifies vendors by approximating an address for the mobile device using the location information of the mobile device, and enumerating all vendors within a predetermined distance from the approximated address of the mobile device.

12. The system of claim 11, wherein the market research application enumerates vendors by:
obtaining, from a vendor database, addresses of vendors having a predetermined zip code,
determining, for each obtained address, a distance from that address to the approximated address of the mobile device, and
selecting, based on the determined distances, a subset of the enumerated vendors.

13. The system of claim 8, wherein the market research application obtains location information by obtaining coordinates of the mobile device.

14. The system of claim 8, wherein the market research application enumerates one or more market research surveys by querying a database for market research surveys associated with the identified vendors.

15. A method comprising:
receiving, by a server, a location associated with a user and a mobile device;
determining, by the server, a research program for a vendor based at least in part on the location;
sending, by the server, information about the research program to the mobile device;
receiving, by the server, a request for participation in the research program;
sending, by the server, at least one inquiry associated with the research program to the mobile device; and
receiving, by the server, a response to the at least one inquiry from the mobile device.

16. The method of claim 15, wherein receiving the location further comprises:
receiving, by the server, coordinates associated with the mobile device.

17. The method of claim 15, wherein determining the research program further comprises:
retrieving, by the server, a location of an enterprise associated with the vendor;
comparing, by the server, a threshold with a distance between the location associated with the mobile device and the location of the enterprise;
selecting, by the server, the research program for the vendor when the threshold exceeds the distance.

18. The method of claim 15, wherein determining the research program further comprises:
selecting, by the server, a plurality of research programs for vendors with enterprises located within a threshold distance of the location associated with the mobile device;
sorting, by the server, the plurality of research programs based at least in part on distances between the location of the mobile device and locations of the enterprises; and
selecting, by the server, a subset of the plurality of research programs based at least in part on the distances.

19. The method of claim 15, wherein determining the research program further comprises:
determining, by the server, the research program based at least in part on information about the user.

20. The method of claim 15, wherein determining the research program further comprises:
determining, by the server, the research program based at least in part on demographic information about the user.

21. The method of claim 15, wherein determining the research program further comprises:
determining, by the server, the research program based at least in part on the user's participation in research programs.

22. The method of claim 15, wherein determining the research program further comprises:
determining, by the server, an amount of compensation for participating in the research program.

23. The method of claim 15, wherein sending the information about the research program further comprises:
sending, by the server, an identity of the vendor and a description of the research program.

24. The method of claim 15, wherein sending the information about the research program further comprises:
sending, by the server, an identity of the vendor, a description of the research program, and information about an amount of compensation for participating in the research program.

25. The method of claim 15, wherein sending the at least one inquiry associated with the research program further comprises:
sending, by the server, a first inquiry to the mobile device; and
sending, by the server, a second inquiry to the mobile device.

26. The method of claim 15, wherein receiving the response to the at least one inquiry further comprises:
receiving, by the server, a first response to a first inquiry associated with the research program; and
receiving, by the server, a second response to a second inquiry associated with the research program.

27. The method of claim 15, wherein receiving the response to the at least one inquiry further comprises:
determining, by the server, acceptability of the response.

28. The method of claim 27, further comprising:
increasing, by the server, an account of the user by an amount of compensation.

29. A method comprising:
receiving, by a mobile device, a request to access at least one research program for a vendor;
determining, by the mobile device, a location of the mobile device;
sending, by the mobile device, the location to a server;
receiving, by the mobile device, information about a research program from the server, the research program based at least in part on the location;
receiving, by the mobile device, a request for participation in the research program;
sending, by the mobile device, the request for participation to the server; and
receiving, by the mobile device, at least one inquiry associated with the research program.

30. The method of claim 29, wherein determining the location of the mobile device further comprises:
receiving, by the mobile device, signals from positioning satellites, and
determining, by the mobile device, the location from the signals.

31. The method of claim 29, wherein determining the location of the mobile device further comprises:
receiving, by the mobile device, coordinates associated with the location of the mobile device.

32. The method of claim 29, wherein receiving the information about the research program further comprises:
displaying, by the mobile device, an identity of the vendor, a location of an enterprise associated with the vendor, a description of the research program, and information about an amount of compensation for participating in the research program.

33. The method of claim 29, further comprising:
sending, by the mobile device, a response to the at least one inquiry to a server.
